(19) United States
(12) Patent Application Publication
(10) Pub. No.: US 2002/0192137 A1
(43) Pub. Date: Dec. 19, 2002

(54) Phosphate powder compositions and methods for forming particles with complex anions

(76) Inventors: Benjamin Chaloner-Gill, San Jose, CA (US); Allison A. Pinoli, Sunnyvale, CA (US); Craig R. Horne, San Francisco, CA (US); Ronald J. Mosso, Fremont, CA (US); Xiangxin Bi, San Ramon, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/845,985

(22) Filed: Apr. 30, 2001

(51) Int. Cl. H01M 4/58; C01B 25/26

(52) U.S. Cl. 423/306; 429/231.95; 252/182.1; 429/221; 429/224; 423/311

(57) ABSTRACT

Nanoscale and submicron particles have been produced with polyatomic anions. The particles can be crystalline or amorphous. The particles are synthesized in a flowing reactor, preferably with an intense light beam driving the reaction. In preferred embodiments, the particles are highly uniform. Batteries can be formed from submicron and nanoscale lithium metal phosphates. Coatings also can be formed from the particles.

### BACKGROUND OF THE INVENTION

The invention relates to particles of compositions with polyatomic anions, in particular, in which the particles are submicron. In addition, the invention relates to method of forming particles with polyatomic anions using a flowing chemical reactor. The invention further relates to electrodes and batteries formed from the phosphate particles.

Advances in a variety of fields have created a demand for many types of new materials. In particular, a variety of chemical powders can be used in many different processing contexts, such as the production of electrical components, optical components, electro-optical components and batteries. Some powder compounds with polyatomic anions are useful in a various application. For example, metal phosphates are candidates for the production of cathode materials that intercalate lithium. Also, some phosphates can be formed into glasses with various uses.

The microminiaturization of electronic components has created widespread growth in the use of portable electronic devices such as cellular phones, pagers, video cameras, facsimile machines, portable stereophonic equipment, personal organizers and personal computers. The growing use of portable electronic equipment has created ever increasing demand for improved power sources for these devices. Similarly, telecommunication backup batteries, hybrid electric vehicles, electric vehicles requires advanced battery materials to meet the high demand and performance required in these contexts. Preferably, the battery materials are environmentally benign and relatively low cost to make these expanded battery applications practical. Relevant batteries include primary batteries, i.e., batteries designed for use through a single charging cycle, and secondary batteries, i.e., batteries designed to be rechargeable. Some batteries designed essentially as primary batteries may be rechargeable to some extent.

Batteries based on lithium have been the subject of considerable development effort and are being sold commercially. Lithium-based batteries have become commercially successful due to their relatively high energy density. Lithium-based batteries generally use electrolytes containing lithium ions. The negative electrodes for these batteries can include lithium metal or alloy (lithium batteries), or compositions that intercalate lithium (lithium ion batteries). Preferred electroactive materials for incorporation into the positive electrodes are compositions that intercalate lithium.

The consolidation or integration of mechanical, electrical and optical components into integral devices has created enormous demands on material processing. Furthermore, the individual components integrated in the devices are shrinking in size. Therefore, there is considerable interest in the formation of specific compositions applied to substrates. In particular, some phosphates can be useful to form glasses or other coatings.

### SUMMARY OF THE INVENTION

In a first aspect, the invention pertains to a collection of particles comprising a crystalline composition with a phosphate anion. The collection of particles has an average particle size less than about 1000 nm. A battery can include a cathode that comprises these submicron crystalline phosphate compositions.

In a further aspect, the invention pertains to a collection of particles comprising a collection of amorphous particles. The particles comprise a phosphate composition and have an average particle size less than about 95 nm.

In another aspect, the invention pertains to a method for producing particles comprising a composition with a polyatomic anion. The method comprises reacting a reactant stream in a gas flow, and the reactant stream comprises an aerosol. The aerosol comprises a polyatomic anion precursor, and the polyatomic anion precursor comprises a phosphorous precursor, a sulfur precursor or a silicon precursor.

In addition, the invention pertains to a method for producing particles comprising a composition with a polyatomic anion. The method comprises reacting a reactant stream in a gas flow, in which the reactant stream comprising a polyatomic anion precursor. The polyatomic anion precursor comprises a phosphorous precursor, a sulfur precursor or a silicon precursor. The reaction is driven by an intense light beam.

Furthermore, the invention pertains to a battery comprising an cathode having lithium intercalating particles. The particles comprise lithium metal phosphate and have an average particle size less than about 1000 nm.

In addition, the invention pertains to a method for producing lithium iron phosphate. The method comprises reacting a lithium precursor, an iron precursor and a phosphorous precursor in the presence of O₂ to produce crystalline lithium iron phosphate.

In a further aspect, the invention pertains to a method for producing a collection of particles comprising a mixed metal phosphate compound. The collection of particles have an average particle size of no more than 1000 nm. The method comprises heating submicron metal oxide particles combined with ammonium phosphate.

Moreover, the invention pertains to a method of coating a substrate. The method comprises reacting a reactant stream to produce a product stream and directing the product stream to a substrate. The reaction of the reactant stream is performed by directing a focused radiation beam at the reactant stream to produce the product stream comprising particles downstream from the radiation beam. The reaction is driven by energy from the radiation beam, and the reactant stream comprises a polyatomic anion precursor. The polyatomic anion precursor comprises a phosphorous precursor, a sulfur precursor or a silicon precursor.

### BRIEF DESCRIPTION OF THE DRAWINGS

FIG. 1 is a schematic, sectional view of an embodiment of a laser pyrolysis apparatus, where the cross section is taken through the middle of the radiation path. The upper insert is a bottom view of the collection nozzle, and the lower insert is a top view of the injection nozzle.

FIG. 2 is a schematic, side view of a reactant delivery apparatus for the delivery of vapor reactants to the laser pyrolysis apparatus of FIG. 1.

FIG. 3 is a schematic, sectional view of a reactant delivery apparatus for the delivery of an aerosol reactant to the laser pyrolysis apparatus of FIG. 1, the cross section being taken through the center of the apparatus.

FIG. 4 is a perspective view of an alternative embodiment of a laser pyrolysis apparatus.

FIG. 5 is a sectional view of the inlet nozzle of the alternative laser pyrolysis apparatus of FIG. 4, the cross section being taken along the length of the nozzle through its center.

FIG. 6 is a sectional view of the inlet nozzle of the alternative laser pyrolysis apparatus of FIG. 4, the cross section being taken along the width of the nozzle through its center.

FIG. 7 is a perspective view of an embodiment of an elongated reaction chamber for performing laser pyrolysis.

FIG. 8 is a schematic, sectional view of an apparatus for heat treating nanoparticles, in which the section is taken through the center of the apparatus.

FIG. 9 is a schematic, sectional view of an oven for heating nanoparticles, in which the section is taken through the center of a tube.

FIG. 10 is a schematic, perspective view of a battery of the invention.

FIG. 11 is a schematic diagram of a light reactive deposition apparatus formed with a particle production apparatus connected to a separate coating chamber through a conduit.

FIG. 12 is a perspective view of a coating chamber where the walls of the chamber are transparent to permit viewing of the internal components.

FIG. 13 is perspective view of a particle nozzle directed at a substrate mounted on a rotating stage.

FIG. 14 is a schematic diagram of a light reactive deposition apparatus in which a particle coating is applied to a substrate within the particle production chamber.

FIG. 15 is a perspective view of a reactant nozzle delivering reactants to a reaction zone positioned near a substrate.

FIG. 16 is a sectional view of the apparatus of FIG. 15 taken along line 16-16.

FIG. 17 is a x-ray diffractogram of a sample of lithium iron phosphate produced by laser pyrolysis under one set of conditions.

FIG. 18 is a transmission electron micrograph of a sample of lithium iron phosphate produced by laser pyrolysis.

FIG. 19 is a schematic sectional view of a test cell taken two screws of the apparatus.

FIG. 20 is a plot of voltage as a function of time over a charge/discharge cycle of a battery formed with lithium iron phosphate produced as described herein.

FIG. 21 is a plot of discharge capacity as a function of cycle number for a test battery produced with lithium iron phosphate produced as described herein.

### DETAILED DESCRIPTION OF THE ILLUSTRATIVE EMBODIMENTS

Flow reactors have been adapted to the synthesis of highly uniform submicron particles with polyatomic anions. In particular, metal or metalloid compounds with polyatomic anions can be formed as submicron or nanoscale particles. Polyatomic anions of particular interest include, for example, phosphates. Lithium metal phosphates are useful in the formation of positive electrode compounds for lithium-based batteries. Other crystalline metal phosphates are of interest for the synthesis of lithium metal phosphates. Some metal or metalloid phosphates can be used to form glasses.

Submicron inorganic particles with various stoichiometries and crystal structures have been produced by pyrolysis, especially laser pyrolysis, alone or with additional processing. It has been discovered that submicron and nanoscale particles can be produced with polyatomic anions using laser pyrolysis and other flowing reactor systems. Using these approaches a variety of new materials can be produced. In particular, approaches have been developed for the synthesis of phosphate particles. The particles can be crystalline and/or amorphous. The cations can be introduced at desired stoichiometries by varying the composition of the reactant stream. By appropriately selecting the composition in the reactant stream and the processing conditions, submicron particles incorporating one or more metal or metalloid elements as cations into the compositions with polyatomic anions can be formed.

Preferred collections of particles with polyatomic anions have an average diameter less than a micron and high uniformity with a narrow distribution of particle diameters. To generate desired submicron particles, a flowing stream reactor, especially laser pyrolysis reactor, can be used either alone or in combination with additional processing. Specifically, laser pyrolysis has been found to be an excellent process for efficiently producing submicron (less than about 1 micron average diameter) and nanoscale (less than about 100 nm average diameter) particles with a narrow distribution of average particle diameters. In addition, submicron particles produced by laser pyrolysis can be subjected to heating under mild conditions to alter the crystal properties and/or the stoichiometry of the particles. Similarly, lithium iron phosphates can be formed in a heat process from ferrous phosphate.

A basic feature of successful application of laser pyrolysis for the production of particles with polyatomic anions is production of a reactant stream containing appropriate anion precursors and cation precursors. Similarly, unless the precursors are an appropriate radiation absorber, an additional radiation absorber is added to the reactant stream. Other additional reactants can be used to adjust the oxidizing/reducing environment in the reactant stream.

In laser pyrolysis, the reactant stream is pyrolyzed by an intense light beam, such as a laser beam. While a laser beam is a convenient energy source, other intense light sources can be used in laser pyrolysis. Laser pyrolysis provides for formation of phases of materials that are difficult to form under thermodynamic equilibrium conditions. As the reactant stream leaves the light beam, the product particles are rapidly quenched. For the production of metal phosphates and mixed metal phosphate, the present approaches have the advantage that the materials can be made in the presence of oxygen. Thus, the production process avoids the need to carefully exclude oxygen from the process apparatus.

Because of the resulting high uniformity and narrow particle size distribution, laser pyrolysis is a preferred approach for producing submicron particles with polyatomic anions. However, other approaches involving flowing reactant streams can be used to synthesize submicron particles with polyatomic anions. Suitable alternative approaches include, for example, flame pyrolysis and thermal pyrolysis. Flame pyrolysis can be performed with a hydrogen-oxygen flame, wherein the flame supplies the energy to drive the pyrolysis. Such a flame pyrolysis approach should produce similar materials as the laser pyrolysis techniques herein, except that flame pyrolysis approaches generally do not produce comparable high uniformity and a narrow particle size distribution that can be obtained by laser pyrolysis. A suitable flame production apparatus used to produce oxides is described in U.S. Pat. No. 5,447,708 to Helble et al., entitled “Apparatus for Producing Nanoscale Ceramic Particles,” incorporated herein by reference. Furthermore, submicron particles with polyatomic anions can be produced by adapting the laser pyrolysis methods with a thermal reaction chamber such as the apparatus described in U.S. Pat. No. 4,842,832 to Inoue et al., “Ultrafine Spherical Particles of Metal Oxide and a Method for the Production Thereof,” incorporated herein by reference.

To perform laser pyrolysis, reactants can be supplied in vapor form. Alternatively, one or more reactants can be supplied as an aerosol. The use of an aerosol provides for the use of a wider range of precursors for laser pyrolysis than are suitable for vapor delivery only. In some cases, less expensive precursors can be used with aerosol delivery. Suitable control of the reaction conditions with the aerosol results in nanoscale particles with a narrow particle size distribution.

In alternative embodiments, the submicron particles with polyatomic anions are formed in a heat treatment step using a submicron precursor material into which the polyatomic anion is introduced in a solid state reaction. For example, submircon or nanoscale metal oxide particles can be reacted with ammonium phosphate to form submicron or nanoscale metal phosphates. The submircon or nanoscale metal oxide particles can be produced by laser pyrolysis or other flowing reactor processes. Laser pyrolysis is a preferred approach to the formation of submicron or nanoscale powders for generating the particles with polyatomic anions with or without a subsequent solid state reaction.

Various forms of compounds, including compounds with lithium and/or other metal cations, can reversibly intercalate lithium atoms and/or ions. Thus, the lithium metal compounds can function as electroactive material within a lithium-based battery. Some of these compounds have polyatomic anions, such as phosphates. The lithium metal phosphate, such as lithium iron phosphate, particles can be incorporated into a positive electrode film with a binder such as a polymer. The film preferably includes additional electrically conductive particles held by the binder along with the lithium metal phosphate particles. A positive electrode film can be used in a lithium battery or a lithium ion battery. The electrolyte for lithium and lithium ion batteries comprises lithium ions.

Batteries based on lithium metal phosphate nanoparticles can have desirable performance characteristics. In particular, the nanoparticles have good cycle-ability. In addition, the nanoparticles can be used to produce smoother electrodes.

A new process has been developed, termed light reactive deposition, to form highly uniform coatings and devices. Light reactive deposition involves a light driven flowing reactor configured for the immediate deposition of particles onto a surface. In particular, a wide range of reaction precursors can be used in either gaseous and/or aerosol form, and a wide range of highly uniform product particles can be efficiently produced. Light reactive deposition can be used to form highly uniform coatings of phosphates and/or mixtures of materials including phosphates.

Particle Synthesis within a Reactant Flow

Laser pyrolysis has been demonstrated to be a valuable tool for the production of submicron and nanoscale particles with polyatomic anions. Other chemical reaction synthesis methods for producing particles with polyatomic anions using a flowing reactant stream in a gas flow are discussed above. The reactant delivery approaches described in detail below can be adapted for producing particles with polyatomic anions, generally, in flow reactant systems, with or without a light source. Laser pyrolysis is a preferred approach for synthesizing the particles with polyatomic anions because laser pyrolysis produces highly uniform and high quality product particles.

The reaction conditions determine the qualities of the particles produced by laser pyrolysis. The reaction conditions for laser pyrolysis can be controlled relatively precisely in order to produce particles with desired properties. The appropriate reaction conditions to produce a certain type of particles generally depend on the design of the particular apparatus. Specific conditions used to produce lithium iron phosphate particles in a particular apparatus are described below in the Examples. Furthermore, some general observations on the relationship between reaction conditions and the resulting particles can be made.

Increasing the light power results in increased reaction temperatures in the reaction region as well as a faster quenching rate. A rapid quenching rate tends to favor production of high energy phases, which may not be obtained with processes near thermal equilibrium. Similarly, increasing the chamber pressure also tends to favor the production of higher energy structures. Also, increasing the concentration of the reactant serving as the oxygen source in the reactant stream favors the production of particles with increased amounts of oxygen.

Reactant flow rate and velocity of the reactant gas stream are inversely related to particle size so that increasing the reactant gas flow rate or velocity tends to result in smaller particle sizes. Light power also influences particle size with increased light power favoring larger particle formation for lower melting materials and smaller particle formation for higher melting materials. Also, the growth dynamics of the particles have a significant influence on the size of the resulting particles. In other words, different forms of a product compound have a tendency to form different size particles from other phases under relatively similar conditions. Similarly, under conditions at which populations of particles with different compositions are formed, each population of particles generally has its own characteristic narrow distribution of particle sizes.

Laser pyrolysis has become the standard terminology for chemical reactions driven by an intense light radiation with rapid quenching of product after leaving a narrow reaction region defined by the light. The name, however, is a misnomer in the sense that a strong, incoherent, but focused light beam can replace the laser. Also, the reaction is not a pyrolysis in the sense of a thermal pyrolysis. The laser pyrolysis reaction is not thermally driven by the exothermic combustion of the reactants. In fact, some laser pyrolysis reactions can be conducted under conditions where no visible flame is observed from the reaction.

To produce particles with polyatomic anions, appropriate precursors are directed into the flowing reactor. One or more precursors are needed to supply the metal/metalloid that form the cation(s) and appropriate precursors must supply the elements that ultimately become the polyatomic anion. Metalloids are elements that exhibit chemical properties intermediate between or inclusive of metals and nonmetals. Metalloid elements include silicon, boron, arsenic, antimony, and tellurium. The polyatomic anion precursor or precursors may include the anion in its final form with the particular desired stoichiometry or the polyatomic anion can form during the laser pyrolysis process by oxidation or reduction of anion precursor(s). A single precursor composition can include aspects of both a cation precursor and an anion precursor and/or forms of compositions that are oxidized or reduced to form the anion precursors.

Particles of particular interest include phosphates compositions. Lithium iron phosphate, other lithium metal phosphates as well as other lithium metal compositions with other polyatomic anions can be used as a cathode active material in lithium-based batteries. Calcium phosphates and aluminum phosphates, for example, can be formed into desirable glasses.

Laser pyrolysis has been performed generally with gas/vapor phase reactants. Many metal precursor compounds can be delivered into the reaction chamber as a gas. Appropriate metal precursor compounds for gaseous delivery generally include metal compounds with reasonable vapor pressures, i.e., vapor pressures sufficient to get desired amounts of precursor gas/vapor into the reactant stream.

The vessel holding liquid or solid precursor compounds can be heated to increase the vapor pressure of the metal precursor, if desired. Solid precursors generally are heated to produce a sufficient vapor pressure. A carrier gas can be bubbled through a liquid precursor to facilitate delivery of a desired amount of precursor vapor. Similarly, a carrier gas can be passed over the solid precursor to facilitate delivery of the precursor vapor.

Suitable lithium precursors for vapor delivery include, for example, solids, such as lithium acetate (Li₂O₂CCH₃), and liquids, such as lithium amide (LiNH₂) dissolved in hexane. Suitable liquid iron precursors for vapor delivery include, for example, iron carbonyl (Fe(CO)₅). Suitable liquid, aluminum precursors include, for example, aluminum s-butoxide (Al(OC₄H₉)₃). A number of suitable solid, aluminum precursor compounds are available including, for example, aluminum chloride (AlCl₃), aluminum ethoxide (Al (OC₂H₅)₃), and aluminum isopropoxide (Al[OCH(CH₃)₂]₃).

Suitable gaseous phosphate precursor compounds for vapor delivery include, for example, phosphine (PH₃), phosphorus trichloride (PCl₃), phosphorous pentachloride (PCl₅), phosphorus oxychloride (POCl₃) and P(OCH₃)₃. Phosphorous oxidizes to phosphates under suitably oxidizing conditions. Phosphate is the highest oxidation state for phosphorous. Thus, for example, to form aluminum phosphate glass, vapor with AlCl₃ and POCl₃ could be reacted by laser pyrolysis.

Suitable gaseous sulfur precursors for vapor delivery include, for example, pyrosulfuryl chloride (S₂O₅Cl₂), sulfur chloride (S₂Cl₂), sulfuryl chloride (SO₂Cl₂) and thionyl chloride (SOCl₂). Sulfur oxidizes to sulfates under suitably oxidizing conditions. Sulfate has the highest oxidation state of sulfur.

Suitable gaseous silicon precursors include, for example, silicon tetrachloride (SiCl₄). Silicon oxidizes under suitably oxidizing conditions to the silicates. Silicate has the highest oxidation state of silica.

The use of exclusively gas phase reactants is somewhat limiting with respect to the types of precursor compounds that can be used conveniently. Thus, techniques have been developed to introduce aerosols containing metal precursors into laser pyrolysis chambers. Improved aerosol delivery apparatuses for reaction systems are described further in commonly assigned and copending U.S. patent application Ser. No. 09/188,670 to Gardner et al. now U.S. Pat. No. 6,193,936, entitled “Reactant Delivery Apparatuses,” incorporated herein by reference.

Using aerosol delivery apparatuses, solid precursor compounds can be delivered by dissolving the compounds in a solvent. Alternatively, powdered precursor compounds can be dispersed in a liquid/solvent for aerosol delivery. Liquid precursor compounds can be delivered as an aerosol from a neat liquid, a multiple liquid dispersion or a liquid solution. Aerosol reactants can be used to obtain a significant reactant throughput. A solvent/dispersant can be selected to achieve desired properties of the resulting solution/dispersion. Suitable solvents/dispersants include water, methanol, ethanol, isopropyl alcohol, other organic solvents and mixtures thereof. The solvent should have a desired level of purity such that the resulting particles have a desired purity level. Some solvents, such as isopropyl alcohol, are significant absorbers of infrared light from a CO₂ laser such that no additional laser absorbing compound may be needed within the reactant stream if a CO₂ laser is used as a light source.

If aerosol precursors are formed with a solvent present, the solvent preferably is rapidly evaporated by the light beam in the reaction chamber such that a gas phase reaction can take place. Thus, the fundamental features of the laser pyrolysis reaction are unchanged by the presence of an aerosol. Nevertheless, the reaction conditions are affected by the presence of the aerosol. Below in the Examples, conditions are described for the production of nanoscale lithium iron phosphate particles using aerosol precursors in a particular laser pyrolysis reaction chamber. Thus, the parameters associated with aerosol reactant delivery can be explored further based on the description below.

Suitable lithium precursors for aerosol delivery from solution include, for example, lithium acetate (LiCH₃CO₂) and lithium nitrate (LiNO₃), which are soluble in water and alcohol, lithium chloride (LiCl), which is somewhat soluble in water, alcohol and some other organic solvents, and lithium hydroxide (LiOH), which is somewhat soluble in water and alcohol. Suitable iron precursors for aerosol delivery include, for example, ferrous chloride (FeCl₂), which is soluble in water, alcohol and acetone, and ferrous acetate (Fe(O₂CCH₃)₂. Suitable aluminum precursors for aerosol delivery include, for example, aluminum chloride (AlCl₃.6H₂O), which is soluble in many organic solvents, and aluminum nitrate (Al(NO₃)₃.9H₂O) and aluminum hydroxychloride (Al₂(OH)₅Cl.2H₂O), which are soluble in water.

Suitable phosphorous precursors for aerosol delivery include, for example, ammonium phosphate ((NH₄)₃PO₄), ammonium phosphate-dibasic ((NH₄)₂HPO₄), ammonium phosphate-monobasic ((NH₄)H₂PO₄) and phosphoric acid (H₃PO₄), which are all moderately soluble in water. Suitable sulfur precursors for aerosol delivery include, for example, ammonium sulfate ((NH₄)₂S) and sulfuric acid (H₂SO₄), which are soluble in water. Suitable silicon precursors for forming silicates include, for example, sodium silicate (Na₂SiO₃) dissolved in aqueous sodium hydroxide (NaOH) especially for the production of sodium containing particles and generally, tetramethylammonium silicate (((CH₃)₄N)OH.SiO₂), which is soluble in water, and tetramethylorthosilicate ((CH₃CH₂O)₄Si), which slowly hydrolyzes in water.

The precursor compounds for aerosol delivery are dissolved in a solution preferably with a concentration greater than about 0.5 molar. Generally, the greater the concentration of precursor in the solution the greater the throughput of reactant through the reaction chamber. As the concentration increases, however, the solution can become more viscous such that the aerosol may have droplets with larger sizes than desired. Thus, selection of solution concentration can involve a balance of factors in the selection of a preferred solution concentration.

Preferred secondary reactants serving as an oxygen source include, for example, O₂, CO, H₂O, CO₂, O₃ and mixtures thereof. Molecular oxygen can be supplied as air. The secondary reactant compound should not react significantly with the metal precursor prior to entering the reaction zone since this generally would result in the formation of large particles. If the reactants are spontaneously reactive, the metal precursor and the secondary reactant can be delivered in separate nozzles into the reaction chamber such that they are combined just prior to reaching the light beam. If the metal precursors includes oxygen, a secondary reactant may not be needed to supply oxygen.

Laser pyrolysis can be performed with a variety of optical frequencies, using either a laser or other strong focused light source. Preferred light sources operate in the infrared portion of the electromagnetic spectrum. CO₂ lasers are particularly preferred sources of light. Infrared absorbers for inclusion in the reactant stream include, for example, C₂H₄, isopropyl alcohol, NH₃, SF₆, SiH₄ and O₃. O₃ can act as both an infrared absorber and as an oxygen source. The radiation absorber, such as the infrared absorber, absorbs energy from the radiation beam and distributes the energy to the other reactants to drive the pyrolysis.

Preferably, the energy absorbed from the light beam increases the temperature at a tremendous rate, many times the rate that heat generally would be produced by exothermic reactions under controlled condition. While the process generally involves nonequilibrium conditions, the temperature can be described approximately based on the energy in the absorbing region. The laser pyrolysis process is qualitatively different from the process in a combustion reactor where an energy source initiates a reaction, but the reaction is driven by energy given off by an exothermic reaction. Thus, while the light driven process is referred to as laser pyrolysis, it is not a thermal process even though traditional pyrolysis is a thermal process.

An inert shielding gas can be used to reduce the amount of reactant and product molecules contacting the reactant chamber components. Inert gases can also be introduced into the reactant stream as a carrier gas and/or as a reaction moderator. Appropriate inert gases include, for example, Ar, He and N₂.

An appropriate laser pyrolysis apparatus generally includes a reaction chamber isolated from the ambient environment. A reactant inlet connected to a reactant delivery apparatus produces a reactant stream with a gas flow through the reaction chamber. A light beam path intersects the reactant stream at a reaction zone. The reactant/product stream continues after the reaction zone to an outlet, where the reactant/product stream exits the reaction chamber and passes into a collection apparatus. Generally, the light source, such as a laser, is located external to the reaction chamber, and the light beam enters the reaction chamber through an appropriate window.

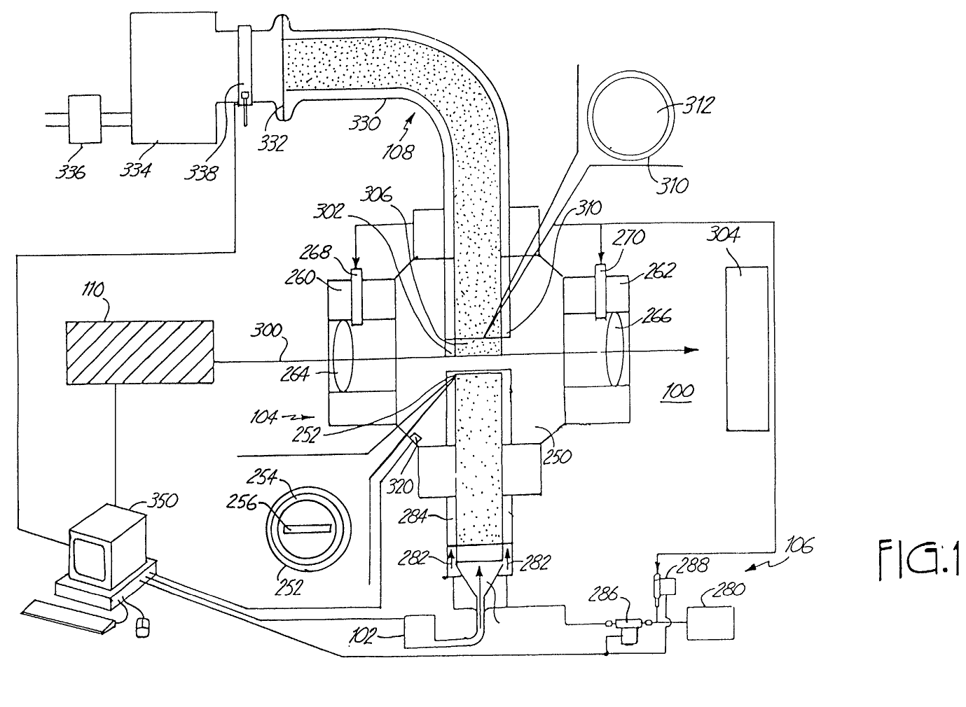

Referring to FIG. 1, a particular embodiment 100 of a laser pyrolysis system involves a reactant delivery apparatus 102, reaction chamber 104, shielding gas delivery apparatus 106, collection apparatus 108 and light source 110. A first reaction delivery apparatus described below can be used to deliver exclusively gaseous reactants. An alternative reactant delivery apparatus is described for delivery of one or more reactants as an aerosol.

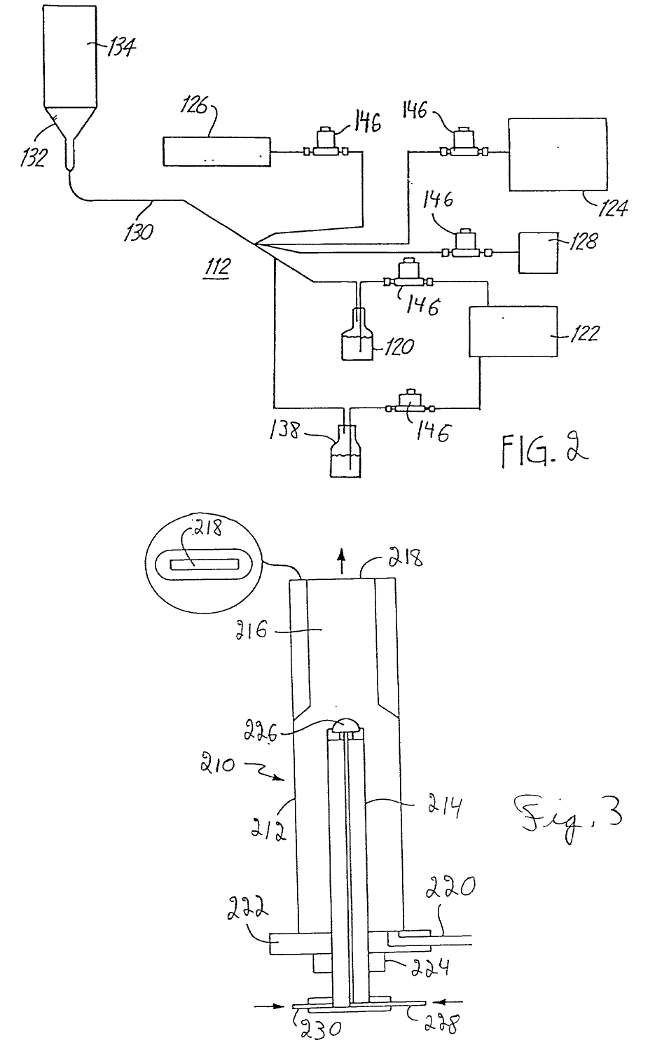

Referring to FIG. 2, a first embodiment 112 of reactant delivery apparatus 102 includes a source 120 of a precursor compound. For liquid or solid reactants, a carrier gas from one or more carrier gas sources 122 can be introduced into precursor source 120 to facilitate delivery of the reactant. Precursor source 120 can be a liquid holding container, a solid precursor delivery apparatus or other suitable container. The carrier gas from carrier gas source 122 preferably is either an infrared absorber and/or an inert gas.

The gases from precursor source 120 are mixed with gases from infrared absorber source 124, inert gas source 126 and/or secondary reactant source 128 by combining the gases in a single portion of tubing 130. The gases are combined a sufficient distance from reaction chamber 104 such that the gases become well mixed prior to their entrance into reaction chamber 104. The combined gas in tube 130 passes through a duct 132 into channel 134, which is in fluid communication with reactant inlet 256 (FIG. 1).

A second reactant can be supplied from second reactant source 138, which can be a liquid reactant delivery apparatus, a solid reactant delivery apparatus, a gas cylinder or other suitable container or containers. As shown in FIG. 2, second reactant source 138 delivers a second reactant to duct 132 by way of tube 130. Alternatively, mass flow controllers 146 can be used to regulate the flow of gases within the reactant delivery system of FIG. 2. In alternative embodiments, the second reactant can be delivered through a second duct for delivery into the reactant chamber through a second channel such that the reactants do not mix until they are in the reaction chamber. A laser pyrolysis apparatus with a plurality of reactant delivery nozzles is described further in copending and commonly assigned U.S. patent application Ser. No. 09/266,202 to Reitz et al., entitled “Zinc Oxide Particles,” incorporated herein by reference.

As noted above, the reactant stream can include one or more aerosols. The aerosols can be formed within reaction chamber 104 or outside of reaction chamber 104 prior to injection into reaction chamber 104. If the aerosols are produced prior to injection into reaction chamber 104, the aerosols can be introduced through reactant inlets comparable to those used for gaseous reactants, such as reactant inlet 134 in FIG. 2.

Referring to FIG. 3, embodiment 210 of the reactant supply system 102 can be used to supply an aerosol to duct 132. Reactant supply system 210 includes an outer nozzle 212 and an inner nozzle 214. Outer nozzle 212 has an upper channel 216 that leads to a rectangular outlet 218 at the top of outer nozzle 212, as shown in the insert in FIG. 3. Rectangular outlet 218 has selected dimensions to produce a reactant stream of desired expanse within the reaction chamber. Outer nozzle 212 includes a drain tube 220 in base plate 222. Drain tube 220 is used to remove condensed aerosol from outer nozzle 212. Inner nozzle 214 is secured to outer nozzle 212 at fitting 224.

The top of inner nozzle 214 preferably is a twin orifice internal mix atomizer 226. Liquid is fed to the atomizer through tube 228, and gases for introduction into the reaction chamber are fed to the atomizer through tube 230. Interaction of the gas with the liquid assists with droplet formation.

Referring to FIG. 1, the reaction chamber 104 includes a main chamber 250. Reactant supply system 102 connects to the main chamber 250 at injection nozzle 252. Reaction chamber 104 can be heated to a surface temperature above the dew point of the mixture of reactants and inert components at the pressure in the apparatus.

The end of injection nozzle 252 has an annular opening 254 for the passage of inert shielding gas, and a reactant inlet 256 (left lower insert) for the passage of reactants to form a reactant stream in the reaction chamber. Reactant inlet 256 preferably is a slit, as shown in the lower inserts of FIG. 1. Annular opening 254 has, for example, a diameter of about 1.5 inches and a width along the radial direction from about ⅛ in to about 1/16 in. The flow of shielding gas through annular opening 254 helps to prevent the spread of the reactant gases and product particles throughout reaction chamber 104.

Tubular sections 260, 262 are located on either side of injection nozzle 252. Tubular sections 260, 262 include, for example, ZnSe windows 264, 266, respectively. Windows 264, 266 are about 1 inch in diameter. Windows 264, 266 are preferably cylindrical lenses with a focal length equal to the distance between the center of the chamber to the surface of the lens to focus the light beam to a point just below the center of the nozzle opening. Windows 264, 266 preferably have an antireflective coating. Appropriate ZnSe lenses are available from Laser Power Optics, San Diego, Calif. Tubular sections 260, 262 provide for the displacement of windows 264, 266 away from main chamber 250 such that windows 264, 266 are less likely to be contaminated by reactants and/or products. Window 264, 266 are displaced, for example, about 3 cm from the edge of the main chamber 250.

Windows 264, 266 are sealed with a rubber o-ring to tubular sections 260, 262 to prevent the flow of ambient air into reaction chamber 104. Tubular inlets 268, 270 provide for the flow of shielding gas into tubular sections 260, 262 to reduce the contamination of windows 264, 266. Tubular inlets 268, 270 are connected to shielding gas delivery apparatus 106.

Referring to FIG. 1, shielding gas delivery system 106 includes inert gas source 280 connected to an inert gas duct 282. Inert gas duct 282 flows into annular channel 284 leading to annular opening 254. A mass flow controller 286 regulates the flow of inert gas into inert gas duct 282. If reactant delivery system 112 of FIG. 2 is used, inert gas source 126 can also function as the inert gas source for duct 282, if desired. Referring to FIG. 1, inert gas source 280 or a separate inert gas source can be used to supply inert gas to tubes 268, 270. Flow to tubes 268, 270 preferably is controlled by a mass flow controller 288.

Light source 110 is aligned to generate a light beam 300 that enters window 264 and exits window 266. Windows 264, 266 define a light path through main chamber 250 intersecting the flow of reactants at reaction zone 302. After exiting window 266, light beam 300 strikes power meter 304, which also acts as a beam dump. An appropriate power meter is available from Coherent Inc., Santa Clara, Calif. Light source 110 can be a laser or an intense conventional light source such as an arc lamp. Preferably, light source 110 is an infrared laser, especially a CW CO₂ laser such as an 1800 watt maximum power output laser available from PRC Corp., Landing, N.J.

Reactants passing through reactant inlet 256 in injection nozzle 252 initiate a reactant stream. The reactant stream passes through reaction zone 302, where reaction involving the metal precursor compounds takes place. Heating of the gases in reaction zone 302 is extremely rapid, roughly on the order of 10⁵ degree C./sec depending on the specific conditions. The reaction is rapidly quenched upon leaving reaction zone 302, and particles 306 are formed in the reactant/product stream. The nonequilibrium nature of the process allows for the production of nanoparticles with a highly uniform size distribution and structural homogeneity.

The path of the reactant stream continues to collection nozzle 310. Collection nozzle 310 has a circular opening 312, as shown in the upper insert of FIG. 1. Circular opening 312 feeds into collection system 108.

The chamber pressure is monitored with a pressure gauge 320 attached to the main chamber. The preferred chamber pressure for the production of the desired oxides generally ranges from about 80 Torr to about 650 Torr.

Collection system 108 preferably includes a curved channel 330 leading from collection nozzle 310. Because of the small size of the particles, the product particles follow the flow of the gas around curves. Collection system 108 includes a filter 332 within the gas flow to collect the product particles. Due to curved section 330, the filter is not supported directly above the chamber. A variety of materials such as Teflon® (polytetrafluoroethylene), stainless steel, glass fibers and the like can be used for the filter as long as the material is inert and has a fine enough mesh to trap the particles. Preferred materials for the filter include, for example, a glass fiber filter from ACE Glass Inc., Vineland, N.J., cylindrical Nomex® filters from AF Equipment Co., Sunnyvale, Calif. and stainless steel filters from All Con World Systems, Seaford, Del.

Pump 334 is used to maintain collection system 108 at a selected pressure. It may be desirable to flow the exhaust of the pump through a scrubber 336 to remove any remaining reactive chemicals before venting into the atmosphere.

The pumping rate is controlled by either a manual needle valve or an automatic throttle valve 338 inserted between pump 334 and filter 332. As the chamber pressure increases due to the accumulation of particles on filter 332, the manual valve or the throttle valve can be adjusted to maintain the pumping rate and the corresponding chamber pressure.

The apparatus is controlled by a computer 350. Generally, the computer controls the light source and monitors the pressure in the reaction chamber. The computer can be used to control the flow of reactants and/or the shielding gas.

The reaction can be continued until sufficient particles are collected on filter 332 such that pump 334 can no longer maintain the desired pressure in the reaction chamber 104 against the resistance through filter 332. When the pressure in reaction chamber 104 can no longer be maintained at the desired value, the reaction is stopped, and filter 332 is removed. With this embodiment, about 1-300 grams of particles can be collected in a single run before the chamber pressure can no longer be maintained. A single run generally can last up to about 10 hours depending on the reactant delivery system, the type of particle being produced and the type of filter being used.

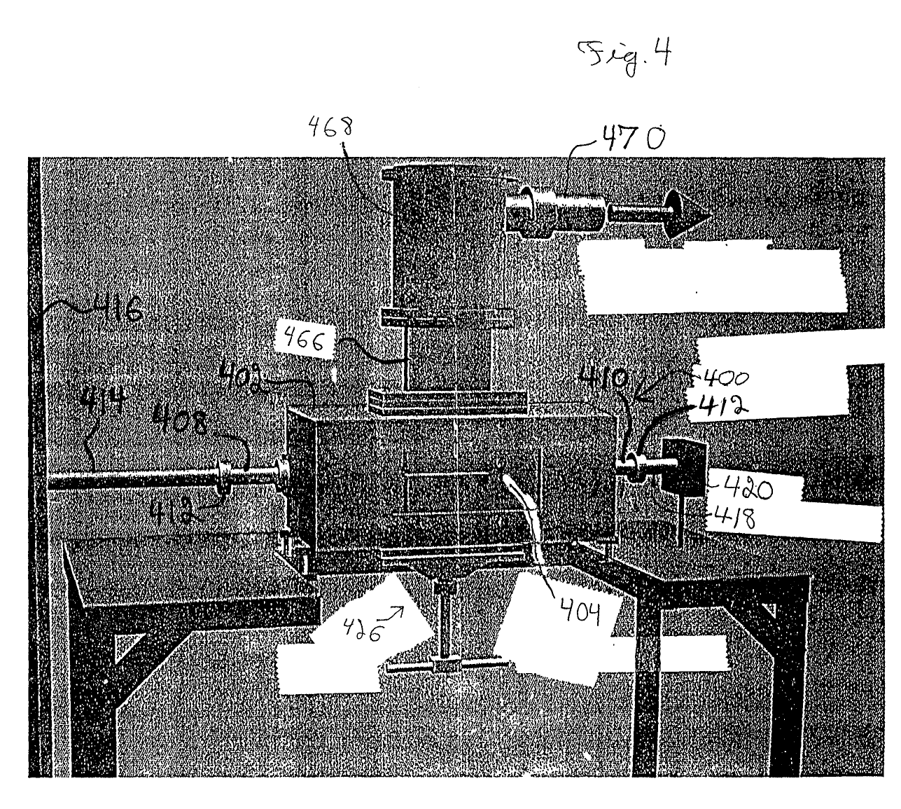

An alternative embodiment of a laser pyrolysis apparatus is shown in FIG. 4. Laser pyrolysis apparatus 400 includes a reaction chamber 402. The reaction chamber 402 has a shape of a rectangular parallelapiped. Reaction chamber 402 extends with its longest dimension along the laser beam. Reaction chamber 402 has a viewing window 404 at its side, such that the reaction zone can be observed during operation.

Reaction chamber 402 has tubular extensions 408, 410 that define an optical path through the reaction chamber. Tubular extension 408 is connected with a seal to a cylindrical lens 412. Tube 414 connects laser 416 or other optical source with lens 412. Similarly, Tubular extension 410 is connected with a seal to tube 418, which further leads to beam dump/light meter 420. Thus, the entire light path from laser 416 to beam dump 420 is enclosed.

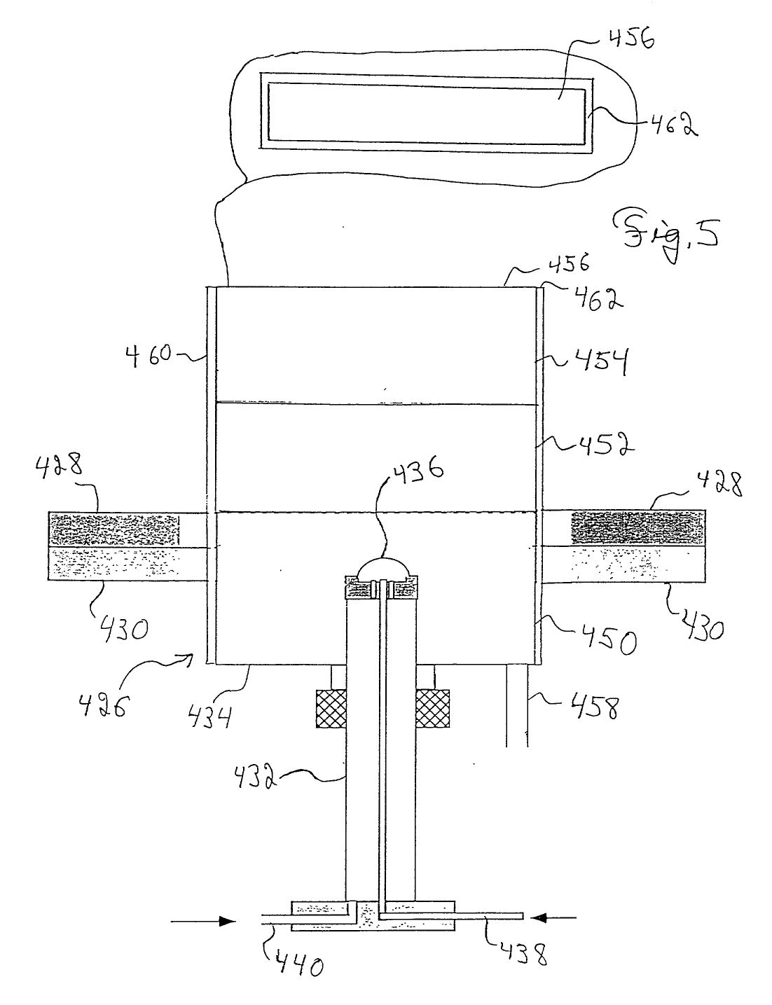

Inlet nozzle 426 connects with reaction chamber 402 at its lower surface 428. Inlet nozzle 426 includes a plate 430 that bolts into lower surface 428 to secure inlet nozzle 426. Referring to sectional views in FIGS. 5 and 6, inlet nozzle 426 includes an inner nozzle 432 and an outer nozzle 434. Inner nozzle 432 preferably has a twin orifice internal mix atomizer 436 at the top of the nozzle. Suitable gas atomizers are available from Spraying Systems, Wheaton, Ill. The twin orifice internal mix atomizer 436 has a fan shape to produce a thin sheet of aerosol and gaseous precursors. Liquid is fed to the atomizer through tube 438, and gases for introduction into the reaction chamber are fed to the atomizer through tube 440. Interaction of the gas with the liquid assists with droplet formation.

Outer nozzle 434 includes a chamber section 450, a funnel section 452 and a delivery section 454. Chamber section 450 holds the atomizer of inner nozzle 432. Funnel section 452 directs the aerosol and gaseous precursors into delivery section 454. Delivery section 450 leads to an about 3 inch by 0.5 inch rectangular outlet 456, shown in the insert of FIG. 5. Outer nozzle 434 includes a drain 458 to remove any liquid that collects in the outer nozzle. Outer nozzle 434 is covered by an outer wall 460 that forms an shielding gas opening 462 surrounding outlet 456. Inert gas is introduced through inlet 464.

Referring to FIG. 4, exit nozzle 466 connects to apparatus 400 at the top surface of reaction chamber 402. Exit nozzle 466 leads to filter chamber 468. Filter chamber 468 connects with pipe 470 which leads to a pump. A cylindrical filter is mounted at the opening to pipe 470. Suitable cylindrical filters are described above.

Another alternative design of a laser pyrolysis apparatus has been described in U.S. Pat. No. 5,958,348 to Bi et al., entitled “Efficient Production of Particles by Chemical Reaction,” incorporated herein by reference. This alternative design is intended to facilitate production of commercial quantities of particles by laser pyrolysis. Additional embodiments and other appropriate features for commercial capacity laser pyrolysis apparatuses are described in copending and commonly assigned U.S. patent application Ser. No. 09/362,631 to Mosso et al., entitled “Particle Production Apparatus,” incorporated herein by reference.

In one preferred embodiment of a commercial capacity laser pyrolysis apparatus, the reaction chamber and reactant inlet are elongated significantly along the light beam to provide for an increase in the throughput of reactants and products. The original design of the apparatus was based on the introduction of purely gaseous reactants. The embodiments described above for the delivery of aerosol reactants can be adapted for the elongated reaction chamber design. Additional embodiments for the introduction of an aerosol with one or more aerosol generators into an elongated reaction chamber are described in commonly assigned and copending U.S. patent application Ser. No. 09/188,670 to Gardner et al. now U.S. Pat. No. 6,193,936, entitled “Reactant Delivery Apparatuses,” incorporated herein by reference.

In general, the laser pyrolysis apparatus with the elongated reaction chamber and reactant inlet is designed to reduce contamination of the chamber walls, to increase the production capacity and to make efficient use of resources. To accomplish these objectives, the elongated reaction chamber provides for an increased throughput of reactants and products without a corresponding increase in the dead volume of the chamber. The dead volume of the chamber can become contaminated with unreacted compounds and/or reaction products. Furthermore, an appropriate flow of shielding gas confines the reactants and products within a flow stream through the reaction chamber. The high throughput of reactants makes efficient use of the laser energy.

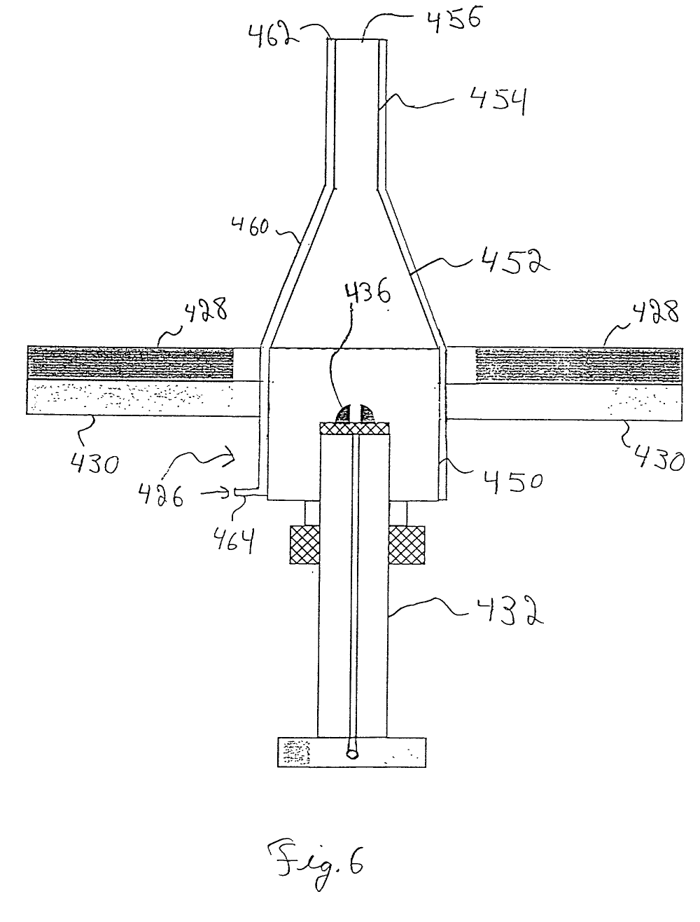

The design of the improved reaction chamber 472 is shown schematically in FIG. 7. A reactant inlet 474 leads to main chamber 476. Reactant inlet 474 conforms generally to the shape of main chamber 476. Main chamber 476 includes an outlet 478 along the reactant/product stream for removal of particulate products, any unreacted gases and inert gases. Shielding gas inlets 480 are located on both sides of reactant inlet 474. Shielding gas inlets are used to form a blanket of inert gases on the sides of the reactant stream to inhibit contact between the chamber walls and the reactants or products. The dimensions of elongated main chamber 476 and reactant inlet 474 preferably are designed for high efficiency particle production. Reasonable lengths for reactant inlet 474 for the production of ceramic nanoparticles, when used with a 1800 watt CO₂ laser, are from about 5 mm to about 1 meter.

Tubular sections 482, 484 extend from the main chamber 476. Tubular sections 482, 484 hold windows 486, 488 to define a light beam path 490 through the reaction chamber 472. Tubular sections 482, 484 can include inert gas inlets 492, 494 for the introduction of inert gas into tubular sections 482, 484.

The improved reaction system includes a collection apparatus to remove the nanoparticles from the reactant stream. The collection system can be designed to collect particles in a batch mode with the collection of a large quantity of particles prior to terminating production. A filter or the like can be used to collect the particles in batch mode. Alternatively, the collection system can be designed to run in a continuous production mode by switching between different particle collectors within the collection apparatus or by providing for removal of particles without exposing the collection system to the ambient atmosphere. A preferred embodiment of a collection apparatus for continuous particle production is described in copending and commonly assigned U.S. patent application Ser. No. 09/107,729 to Gardner et al., entitled “Particle Collection Apparatus And Associated Methods,” incorporated herein by reference.

B. Heat Processing

Significant properties of submicron and nanoscale particles can be modified by heat processing. Suitable starting material for the heat treatment include particles produced by laser pyrolysis. In addition, particles used as starting material for a heat treatment process can have been subjected to one or more prior heating steps under different conditions. For the heat processing of particles formed by laser pyrolysis, the additional heat processing can improve/alter the crystallinity, remove contaminants, such as elemental carbon, and/or alter the stoichiometry, for example, by incorporation of additional oxygen or removal of oxygen.

Of particular interest, particles with polyatomic anions formed by laser pyrolysis can be subjected to a heat processing step. This heat processing can be used to convert these particles into desired high quality crystalline forms if the laser pyrolysis does not directly result in desired crystalline compositions. The heat processing under mild conditions may also remove some trace impurities.

In alternative embodiments, desired particles are performed in the heat treatment process. For example, lithium iron phosphate can be formed by the heat driven reaction, for example, of Li₂CO₃ and NH₄H₂PO₄ with submiron or nanoscale FeO. The metal oxide sets the scale for the product material. Generally, submicron or nanoscale metal phosphate particles can be produced by the heat driven reaction of a submicron or nanoscale metal oxide particle along with NH₄H₂PO₄. Similarly, mixed metal oxide phosphate particles can be produced from submicron or nanoscale metal oxide particles that are mixed with NH₄H₂PO₄ and heated. While NH₄H₂PO₄ is the stable form of ammonium phosphate in air, other forms of ammonium phosphate, i.e., (NH₄)₃PO₄ and (NH₄)₂HPO₄, can be used. The heating for the solid state reaction can be performed at mild temperatures below the melting temperature of the metal oxides or the metal phosphates to reduce any sintering of the particles and maintain the small particle size and uniformity.

In preferred embodiments, the heat treatment is under suitably mild conditions to maintain substantially the submicron or nanoscale size and size uniformity of the particles from laser pyrolysis. In other words, particle size is not compromised significantly by thermal processing, such that significant amounts of particle sintering does not occur. The temperature of heating preferably is low relative to the melting point of the starting material and the product material. Generally, with nanoscale materials, lower heating temperatures can be used to perform any heat processing.

The particles are heated in an oven or the like to provide generally uniform heating. The atmosphere over the particles can be static, or gases can be flowed through the system. The atmosphere for the heating process can be an oxidizing atmosphere, a reducing atmosphere or an inert atmosphere. In particular, for conversion of amorphous particles to crystalline particles or from one crystalline structure to a different crystalline structure of essentially the same stoichiometry, the atmosphere generally can be inert.

Appropriate oxidizing gases include, for example, O₂, O₃, CO, CO₂, and combinations thereof. The O₂ can be supplied as air. Reducing gases include, for example, H₂. Oxidizing gases or reducing gases optionally can be mixed with inert gases such as Ar, He and N₂. When inert gas is mixed with the oxidizing/reducing gas, the gas mixture can include from about 1 percent oxidizing/reducing gas to about 99 percent oxidizing/reducing gas, and more preferably from about 5 percent oxidizing/reducing gas to about 99 percent oxidizing/reducing gas. Alternatively, either essentially pure oxidizing gas, pure reducing gas or pure inert gas can be used, as desired. Care must be taken with respect to the prevention of explosions when using highly concentrated reducing gases.

The precise conditions can be altered to vary the type of particles that are produced. For example, the temperature, time of heating, heating and cooling rates, the surrounding gases and the exposure conditions with respect to the gases can all be selected to produce desired product particles. Generally, while heating under an oxidizing atmosphere, the longer the heating period the more oxygen that is incorporated into the material, prior to reaching equilibrium. Once equilibrium conditions are reached, the overall conditions determine the crystalline phase of the powders. LiFePO₄, unlike most other compounds with the ferrous (Fe⁺²) form of iron, does not oxidize readily to ferric (Fe⁺³) form of iron upon exposure to air and heat.

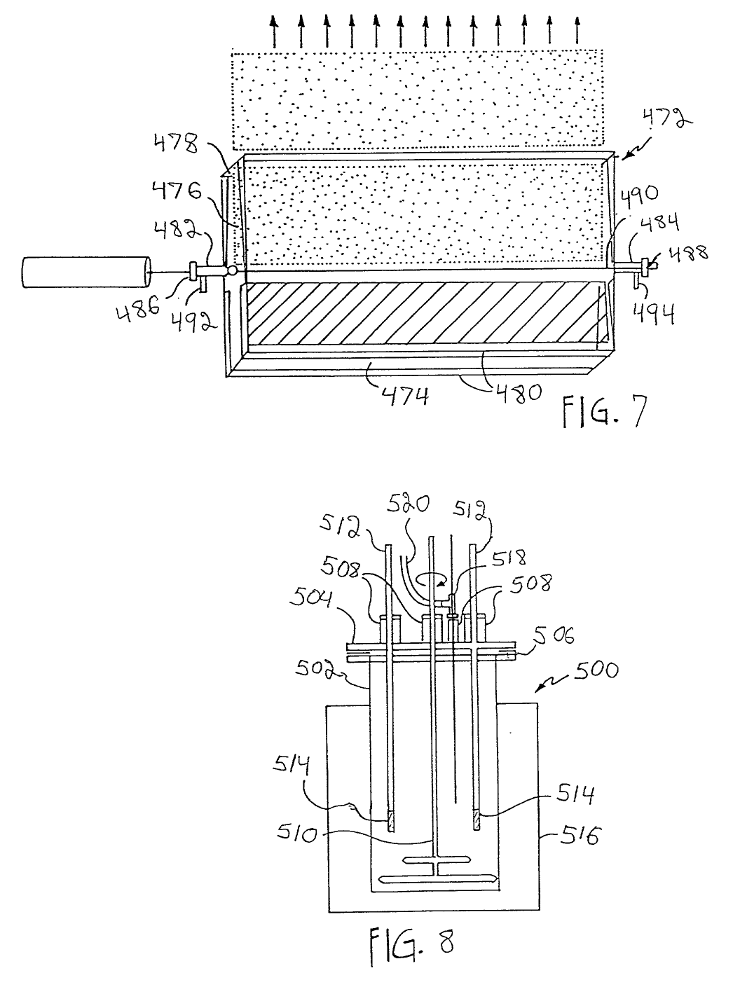

A variety of ovens or the like can be used to perform the heating. An example of an apparatus 500 to perform this processing is displayed in FIG. 8. Apparatus 500 includes a jar 502, which can be made from glass or other inert material, into which the particles are placed. Suitable glass reactor jars are available from Ace Glass (Vineland, N.J.). For higher temperatures alloy jars can be used to replace the glass jars. The top of glass jar 502 is sealed to a glass cap 504, with a Teflon® gasket 506 between jar 502 and cap 504. Cap 504 can be held in place with one or more clamps. Cap 504 includes a plurality of ports 508, each with a Teflon® bushing. A multiblade stainless steel stirrer 510 preferably is inserted through a central port 508 in cap 504. Stirrer 510 is connected to a suitable motor.

One or more tubes 512 are inserted through ports 508 for the delivery of gases into jar 502. Tubes 512 can be made from stainless steel or other inert material. Diffusers 514 can be included at the tips of tubes 512 to disburse the gas within jar 502. A heater/furnace 516 generally is placed around jar 502. Suitable resistance heaters are available from Glas-col (Terre Haute, Ind.). One port preferably includes a T-connection 518. The temperature within jar 502 can be measured with a thermocouple 518 inserted through T-connection 518. T-connection 518 can be further connected to a vent 520. Vent 520 provides for the venting of gas circulated through jar 502. Preferably vent 520 is vented to a fume hood or alternative ventilation equipment.

Preferably, desired gases are flowed through jar 502. Tubes 512 generally are connected to an oxidizing gas source and/or an inert gas source. Oxidizing gas, inert gas or a combination thereof to produce the desired atmosphere are placed within jar 502 from the appropriate gas source(s). Various flow rates can be used. The flow rate preferably is between about 1 standard cubic centimeters per minute (sccm) to about 1000 sccm and more preferably from about 10 sccm to about 500 sccm. The flow rate generally is constant through the processing step, although the flow rate and the composition of the gas can be varied systematically over time during processing, if desired. Alternatively, a static gas atmosphere can be used.

An alternative apparatus 530 for the heat treatment of modest quantities of nanoparticles is shown in FIG. 9. The particles are placed within a boat 532 or the like within tube 534. Tube 534 can be produced from, for example, quartz, alumina or zirconia. Preferably, the desired gases are flowed through tube 534. Gases can be supplied for example from inert gas source 536 or oxidizing gas source 538.

Tube 534 is located within oven or furnace 540. Oven 540 can be adapted from a commercial furnace, such as Mini-Mite™ 1100° C. Tube Furnace from Lindberg/Blue M, Asheville, N.C. Oven 540 maintains the relevant portions of the tube at a relatively constant temperature, although the temperature can be varied systematically through the processing step, if desired. The temperature can be monitored with a thermocouple 542.

Preferred temperature ranges depend on the starting material and the target product particles. For the processing of nanoscale particles with polyatomic anions, the temperature preferably ranges from about 200° C. to about 850° C., preferably from about 200° C. to about 600° C., and more preferably from about 500° C. to about 550° C. The heating generally is continued for greater than about 5 minutes, and typically is continued for from about 10 minutes to about 12 hours, in most circumstances from about 10 minutes to about 5 hours. Preferred heating times also will depend on the particular starting material and target product. Some empirical adjustment may be helpful to produce the conditions appropriate for yielding a desired material. Typically, submicron and nanoscale powders can be processed at lower temperatures while still achieving the desired products. To prevent particle growth, the particles preferably are heated for short periods of time at high temperatures or for longer periods of time at lower temperatures. Some controlled sintering of the particles can be performed at somewhat higher temperatures to produce slightly larger, average particle diameters.

As noted above, heat treatment can be used to perform a variety of desirable transformations for nanoparticles. For example, the conditions to convert crystalline VO₂ to orthorhombic V₂O₅ and 2-D crystalline V₂O₅, and amorphous V₂O₅ to orthorhombic V₂O₅ and 2-D crystalline V₂O₅ are describe in U.S. Pat. No. 5,989,514, to Bi et al., entitled “Processing of Vanadium Oxide Particles With Heat,” incorporated herein by reference. Conditions for the removal of carbon coatings from metal oxide nanoparticles is described in copending and commonly assigned U.S. patent application Ser. No. 09/123,255, entitled “Metal (Silicon) Oxide/Carbon Composite Particles,” incorporated herein by reference. The incorporation of lithium from a lithium salt into metal oxide nanoparticles in a heat treatment process is described in copending and commonly assigned U.S. patent application Ser. No. 09/311,506 to Reitz et al., entitled “Metal Vanadium Oxide Particles,” and copending and commonly assigned U.S. patent application Ser. No. 09/334,203 to Kumar et al., entitled “Reaction Methods for Producing Ternary Particles,” both of which are incorporated herein by reference.

C. Particle Properties

A collection of particles of interest generally has an average diameter for the primary particles of less than about 1000 nm, in most embodiments less than about 500 nm, in other embodiments from about 2 nm to about 100 nm, in some embodiments from about 2 nm to about 95 nm, in further embodiments from about 5 nm to about 75 nm, and still other embodiments from about 5 nm to about 50 nm. A person of ordinary skill in the art will recognize that average diameter ranges within these specific ranges are also contemplated and are within the present disclosure. Particle diameters generally are evaluated by transmission electron microscopy. Diameter measurements on particles with asymmetries are based on an average of length measurements along the principle axes of the particle.

The primary particles usually have a roughly spherical gross appearance, although some nonspherical aspects can be observed along with some necking. After heat treatment, the particles may be less spherical. Upon closer examination, crystalline particles generally have facets corresponding to the underlying crystal lattice. Nevertheless, crystalline primary particles tend to exhibit growth in laser pyrolysis that is roughly equal in the three physical dimensions to give a gross spherical appearance. Amorphous particles generally have an even more spherical aspect. In some embodiments, 95 percent of the primary particles, and preferably 99 percent, have ratios of the dimension along the major axis to the dimension along the minor axis less than about 2.

Because of their small size, the primary particles tend to form loose agglomerates due to van der Waals and other electromagnetic forces between nearby particles. These agglomerates can be dispersed to a significant degree or essentially completely, if desired. Even though the particles form loose agglomerates, the nanometer scale of the primary particles is clearly observable in transmission electron micrographs of the particles. The particles generally have a surface area corresponding to particles on a nanometer scale as observed in the micrographs. Furthermore, the particles can manifest unique properties due to their small size and large surface area per weight of material. For example, vanadium oxide nanoparticles can exhibit surprisingly high energy densities in lithium batteries, as described in U.S. Pat. No. 5,952,125 to Bi et al., entitled “Batteries With Electroactive Nanoparticles,” incorporated herein by reference.

The primary particles preferably have a high degree of uniformity in size. Laser pyrolysis, as described above, generally results in particles having a very narrow range of particle diameters. Furthermore, heat processing under suitably mild conditions does not alter the very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. As determined from examination of transmission electron micrographs, the primary particles generally have a distribution in sizes such that at least about 95 percent, and preferably 99 percent, of the primary particles have a diameter greater than about 40 percent of the average diameter and less than about 225 percent of the average diameter. Preferably, the primary particles have a distribution of diameters such that at least about 95 percent, and preferably 99 percent, of the primary particles have a diameter greater than about 45 percent of the average diameter and less than about 200 percent of the average diameter.

Furthermore, in preferred embodiments no primary particles have an average diameter greater than about 5 times the average diameter and preferably 4 times the average diameter, and more preferably 3 times the average diameter. In other words, the particle size distribution effectively does not have a tail indicative of a small number of particles with significantly larger sizes relative to the average size. This is a result of the small reaction zone and corresponding rapid quench of the particles. An effective cut off in the tail of the size distribution indicates that there are less than about 1 particle in 10⁶ have a diameter greater than a specified cut off value above the average diameter. Narrow size distributions, lack of a tail in the distributions and the roughly spherical morphology can be exploited in a variety of applications.

In addition, the nanoparticles generally have a very high purity level. The nanoparticles produced by the above described methods are expected to have a purity greater than the reactants because the laser pyrolysis reaction and, when applicable, the crystal formation process tends to exclude contaminants from the particle. Furthermore, crystalline nanoparticles produced by laser pyrolysis have a high degree of crystallinity. Similarly, the crystalline nanoparticles produced by heat processing have a high degree of crystallinity. Certain impurities on the surface of the particles may be removed by heating the particles to achieve not only high crystalline purity but high purity overall.

The powders of interest include a polyatomic anion. Preferred polyatomic anions include, for example, phosphate (PO₄⁻³), sulfate (SO₄⁻²) and silicate (SiO₄⁻⁴). Suitable phosphorous precursors for forming the phosphate anion, sulfur precursors for forming the sulfate anion and silicon precursors for forming the silicate anion are discussed above.

Suitable cations include, for example, metal and metalloid cations. For battery applications, lithium metal phosphates are of particular interest. Specifically, lithium iron phosphate is a useful electroactive material for positive electrodes. Crystalline lithium iron phosphate has an olivine structure that allows for a high diffusion rate of Li⁺. The high diffusion rate can lead to a corresponding high rate battery.

In the olivine structure, the lattice has a slightly distorted hexagonal-close-packed array of oxygen atoms. The iron atoms occupy zig-zag chains along corner-shared octahedral sites while the lithium atoms occupy linear chains along edge-shared octahedral sites. The crystal structure is described further in “Effect of Structure on the Fe⁺³/Fe⁺² Redox Couple in Iron Phosphates,” by Padhi et al., J. Electrochem. Soc. 144:1609-1613 (May 1997), incorporated herein by reference.

Other olivine crystal structures are formed by LiMPO₄, where M is a first row transition metal cation. Preferred metals for M in the lithium metal phosphates include, for example, Mn, Fe, Co, Ti, Ni and combinations thereof. Preferred compositions with a combination of first row transition metal cations include, for example, Li₁₋₂ₓFe₁₋ₓTiₓPO₄ with 0.01≦x≦0.99 and LiFe₁₋ₓMnₓPO₄, 0.01≦x≦0.8. Other compounds with a formula of LiMPO₄ and having an olivine crystal structure may also have advantageous properties in batteries. These lithium metal oxides are described further in U.S. Pat. No. 5,910,382 to Goodenough et al., “Cathode Materials For Secondary (Rechargeable) Lithium Batteries,” incorporated herein by reference.

Phosphate glasses can be used in a variety of contexts. Phosphate compositions for glasses include, for example, aluminum phosphate (AlPO₄) and calcium phosphate (Ca₃(PO₄)₂).

D. Battery Applications

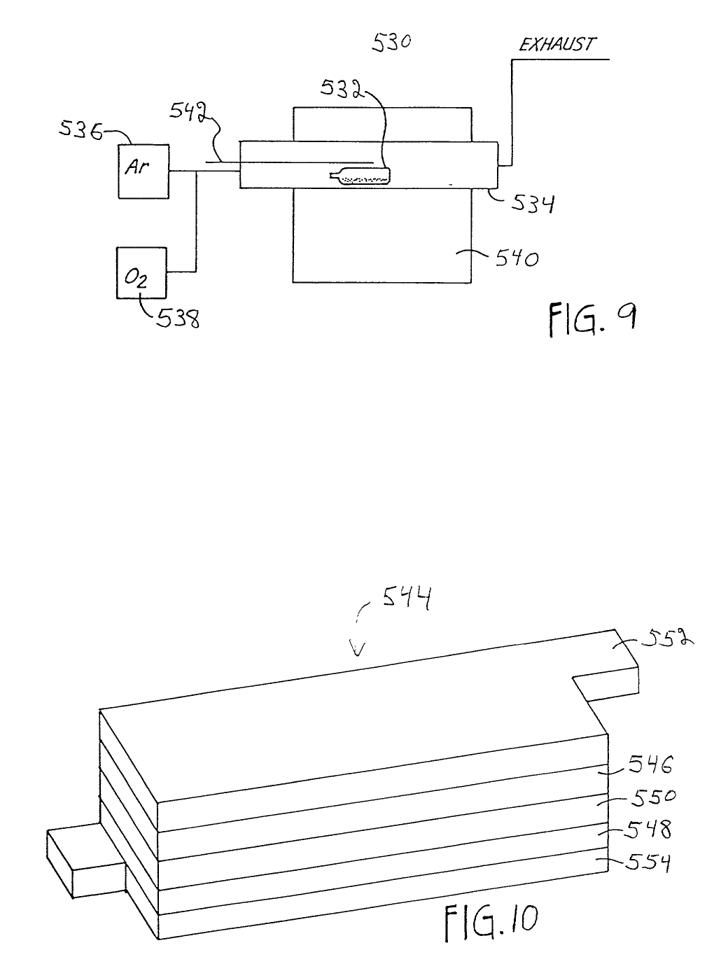

Referring to FIG. 10, battery 544 has an negative electrode 546, a positive electrode 548 and separator 550 between negative electrode 546 and positive electrode 548. A single battery can include multiple positive electrodes and/or negative electrodes. Electrolyte can be supplied in a variety of ways as described further below. Battery 544 preferably includes current collectors 552, 554 associated with negative electrode 546 and positive electrode 548, respectively. Multiple current collectors can be associated with each electrode if desired.

Lithium has been used advantageously in reduction/oxidation reactions in batteries because it is the lightest metal and because it is the most electropositive metal. Batteries that use lithium metal as the negative electrode are termed lithium batteries, while batteries that use lithium intercalation compounds as the electroactive material in the negative electrode are termed lithium ion batteries. Some additional terms have been used to described other lithium-based batteries that have specific types of electrolyte/separator structures, but herein a reference to lithium ion batteries is used to describe all lithium-based batteries with a lithium intercalation compound in the negative electrode regardless of the nature of the electrolyte and separator.

Lithium ions can migrate into and out from LiFePO₄ olivine lattice without large changes in the crystal lattice. Removal of lithium ions from LiFePO₄ result in Li₁₋ₓFePO₄ in which iron ions oxidize from +2 to +3 to maintain overall neutrality. The oxidation and reduction of the iron as lithium ions leave or enter, respectively, the lattice results in the activity of the material in an electrode.

Other lithium metal phosphates with an olivine structure have the general formula of LiMPO₄, where M is one or more metal ions, generally first row transition metal ions. Preferred lithium metal phosphates other than lithium iron phosphate include, for example, LiCoPO₄, LiNiPO₄, Li₁₋₂ₓFe₁₋ₓTiₓPO₄ with 0.01≦x≦0.99 and LiFe₁₋ₓMnₓPO₄, 0.01≦x≦0.8, preferably 0.4≦x≦0.8 and more preferably 0.6≦x≦0.8.

Lithium enters into the lattice of the lithium metal phosphate particles in the positive electrode during discharge of the battery. Upon discharge, the positive electrode acts as a cathode and the negative electrode acts as an anode. The lithium leaves the lattice of the particles in the positive electrode upon recharging, i.e., when a voltage is applied to the cell such that electric current flows into the positive electrode due to the application of an external EMF to the battery. Appropriate lithium metal phosphates can be an effective electroactive material for a positive electrode in either a lithium or lithium ion battery.

Positive electrode 548 preferably includes electroactive lithium metal phosphate nanoparticles, such as lithium iron phosphate nanoparticles. The electroactive nanoparticles are held together with a binder such as a polymeric binder. Nanoparticles for use in positive electrode 548 generally can have any shape, e.g., roughly spherical nanoparticles or elongated nanoparticles.

Negative electrode 546 can be constructed from a variety of materials that are suitable for use with lithium ion electrolytes. In the case of lithium batteries, the negative electrode can include lithium metal or lithium alloy metal either in the form of a foil, grid or metal particles in a binder. Lithium ion batteries use particles in the negative electrode of a composition that can intercalate lithium. The particles in the negative electrode generally are held with a binder.

Suitable intercalation compounds for the negative electrode include, for example, graphite, synthetic graphite, coke, mesocarbons, doped carbons, fullerenes, niobium pentoxide, tin alloys, TiO₂, SnO₂, and mixtures and composites thereof. Submicron and nanoscale SnO₂ particles are described in copending and commonly assigned U.S. patent application Ser. No. 09/042,227, now U.S. Pat. No. 6,200,674 to Kumar et al., entitled “TIN OXIDE PARTICLES,” incorporated herein by reference. Suitable intercalation compounds for the negative electrode include certain lithium metal oxides. For example, lithium titanium oxide is suitable as a low voltage cathode active material or as a low voltage anode active material. Submicron and nanoscale lithium titanium oxide particles are described in copending and commonly assigned U.S. patent application Ser. No. 09/595,958 to Kumar et al., entitled “Lithium Metal Oxides,” incorporated herein by reference.

While some electroactive materials are reasonable electrical conductors, an electrode generally includes electrically conductive particles in addition to the electroactive nanoparticles. These supplementary, electrically conductive particles generally are also held by the binder. Suitable electrically conductive particles include conductive carbon particles such as carbon black, metal particles such as silver particles, stainless steel fibers and the like.

High loadings of particles can be achieved in the binder. Particles preferably make up greater than about 80 percent by weight of an electrode, and more preferably greater than about 90 percent by weight. The binder can be any of various suitable polymers such as polyvinylidene fluoride, polyethylene oxide, polyethylene, polypropylene, polytetrafluoro ethylene, polyacrylates, ethylene-(propylene-diene monomer) copolymer (EPDM) and mixtures and copolymers thereof.

Current collectors 552, 554 facilitate flow of electricity from battery 544. Current collectors 552, 554 are electrically conductive and generally made of metal such as nickel, iron, stainless steel, aluminum and copper and can be metal foil or preferably a metal grid. Current collector 552, 554 can be on the surface of their associated electrode or embedded within their associated electrode.

The separator 550 is electrically insulating and provides for passage of at least some types of ions. For lithium based batteries, the separator must provide for the passage of lithium ions. Ionic transmission through the separator provides for electrical neutrality in the different sections of the cell during discharge and recharge. The separator generally prevents electroactive compounds in the positive electrode from contacting electroactive compounds in the negative electrode.

A variety of materials can be used for the separator. For example, the separator can be formed from glass fibers that form a porous matrix. Preferred separators are formed from polymers such as those suitable for use as binders. Polymer separators can be porous to provide for ionic conduction.

Electrolytes for lithium batteries or lithium ion batteries can include any of a variety of lithium salts. Preferred lithium salts have inert anions and are nontoxic. Suitable lithium salts include, for example, lithium hexafluorophosphate, lithium hexafluoroarsenate, lithiumbis(trifluoromethyl sulfonyl imide), lithium trifluoromethane sulfonate, lithium tris(trifluoromethyl sulfonyl)methide, lithium tetrafluoroborate, lithium perchlorate, lithium tetrachloroaluminate, lithium chloride and mixtures thereof.

If a liquid solvent is used to dissolve the electrolyte, the solvent preferably is inert and does not dissolve the electroactive materials. Generally appropriate solvents include, for example, propylene carbonate, dimethyl carbonate, diethyl carbonate, 2-methyl tetrahydrofuran, dioxolane, tetrahydrofuran, 1,2-dimethoxyethane, ethylene carbonate, γ-butyrolactone, dimethyl sulfoxide, acetonitrile, formamide, dimethylformamide and nitromethane.

Alternatively, polymer separators can be solid electrolytes formed from polymers such as polyethylene oxide. Solid electrolytes incorporate electrolyte into the polymer matrix to provide for ionic conduction without the need for liquid solvent. In addition, solid state separators are possible based on inorganic materials. For example, suitable solid state electrolytes include, for example, lithium phosphorous oxynitride (LIPON), Li_{0.33}La_{0.56}TiO₃ (see Brouse et al., J. Power Sources 68:412 (1997), incorporated herein by reference) and Li₂ₓSr₁₋₂ₓM_{0.5-x}Ti_{0.5+x}O₃ where M is a metal, such as Cr, Fe, Co, Al, In or Y, with a preferred form being Li_{0.5}Sr_{0.5}(Fe or Cr)_{0.25}Ti_{0.75}O₃ (see Watanabe, J. Power Sources 68: 421 (1997), incorporated herein by reference).

Nanoparticles of the lithium metal oxide solid electrolytes, such as Li_{0.33}La_{0.56}TiO₃, can be produced by the methods described in copending and commonly assigned U.S. patent application Serial No. 09/595,958 to Kumar et al., entitled “Lithium Metal Oxides,” incorporated herein by reference. These lithium metal oxide solid electrolyte nanoparticles can be deposited as a powder onto an electrode and densified to form a thin film. Because of the small size of the particles, very thin layers can be formed. The other electrode can be laminated to the first electrode with the solid electrolyte powder between the two electrodes. The thickness of the densified solid electrolyte between the electrodes can be adjusted to limit short circuiting and contact between positive and negative electroactive particles to acceptable levels. The formation of thin battery structures based on nanoparticles is described further in copending and commonly assigned U.S. patent application Ser. No. 09/435,748 to Buckley et al., entitled “Electrodes,” incorporated herein by reference. Also, the formation of separators from densified nanoparticles is described in U.S. Pat. No. 5,905,000 to Yadev et al., entitled “Nanostructured Ion Conducting Solid Electrolytes,” incorporated herein by reference.

The shape of the battery components can be adjusted to be suitable for the desired final product, for example, a coin battery, a prismatic construction or a cylindrical battery. The battery generally includes a casing with appropriate components in electrical contact with current collectors and/or electrodes of the battery. If a liquid electrolyte is used, the casing should prevent the leakage of the electrolyte. The casing can help to maintain the battery elements in close proximity to each other to reduce electrical and ionic resistances within the battery. A plurality of battery cells can be placed in a single case with the cells connected either in series or in parallel.

E. Coating deposition

Light reactive deposition is a coating approach that uses an intense light source to drive synthesis of desired composition from a reactant stream. It has similarities with laser pyrolysis in that an intense light source drives the reaction. However, in light reactive deposition, the resulting compositions are directed to a substrate surface where a coating is formed. The characteristics of laser pyrolysis that lead to the production of highly uniform particles result in the production of coatings with high uniformity.

In light reactive deposition, the coating of the substrate can be performed in a coating chamber separate from the reaction chamber or the coating can be performed within the reaction chamber. In either of these configurations, the reactant delivery system can be configured similar to a reactant delivery system for a laser pyrolysis apparatus for the production of phosphates and other compositions with polyatomic anions. Thus, the description of the production of particles with polyatomic anions by laser pyrolysis described above and in the examples below can be adapted for coating production using the approaches described in this section.

If the coating is performed in a coating chamber separate from the reaction chamber, the reaction chamber is essentially the same as the reaction chamber for performing laser pyrolysis, although the throughput and the reactant stream size may be designed to be appropriate for the coating process. For these embodiments, the coating chamber and a conduit connecting the coating chamber with the reaction chamber replace the collection system of the laser pyrolysis system.

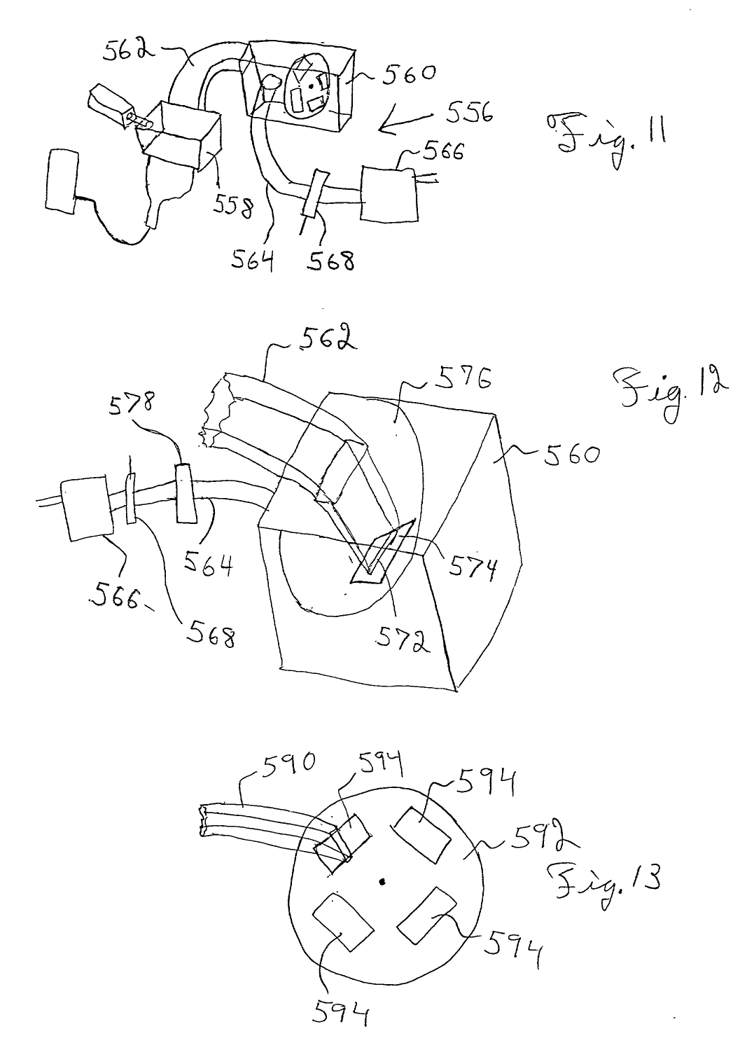

A coating apparatus with a separate reaction chamber and a coating chamber is shown schematically in FIG. 11. Referring to FIG. 11, the coating apparatus 556 comprises a reaction chamber 558, a coating chamber 560, a conduit 562 connecting the reaction apparatus with coating chamber 560, an exhaust conduit 564 leading from coating chamber 560 and a pump 566 connected to exhaust conduit 564. A valve 568 can be used to control the flow to pump 566. Valve 568 can be, for example, a manual needle valve or an automatic throttle valve. Valve 568 can be used to control the pumping rate and the corresponding chamber pressures.

Referring to FIG. 12, conduit 562 from the particle production apparatus 558 leads to coating chamber 560. Conduit 562 terminates at opening 572 within chamber 560. In some preferred embodiments, opening 572 is located near the surface of substrate 574 such that the momentum of the particle stream directs the particles directly onto the surface of substrate 574. Substrate 574 can be mounted on a stage or other platform 576 to position substrate 574 relative to opening 572. A collection system, filter, scrubber or the like 578 can be placed between the coating chamber 560 and pump 566 to remove particles that did not get coated onto the substrate surface.

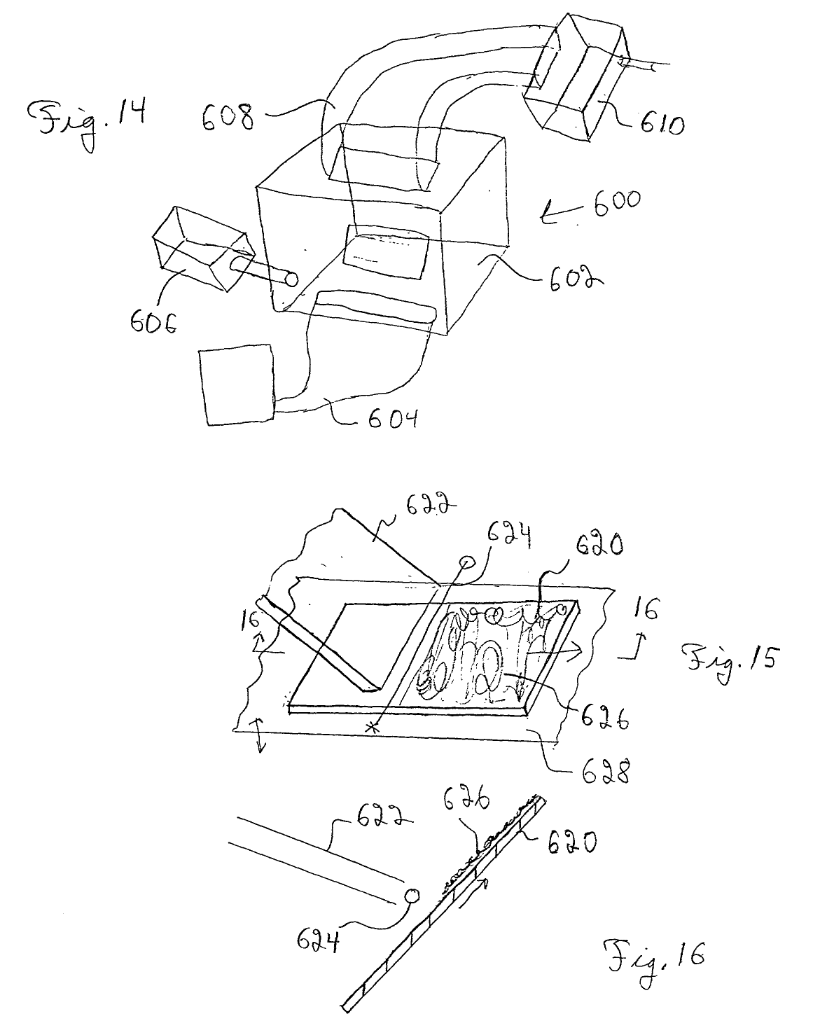

An embodiment of a stage to position a substrate relative to the conduit from the particle production apparatus is shown in FIG. 13. A particle nozzle 590 directs particles toward a rotating stage 592. As shown in FIG. 13, four substrates 594 are mounted on stage 592. More or fewer substrates can be mounted on a moveable stage with corresponding modifications to the stage and size of the chamber. Movement of stage 592 sweeps the particle stream across a substrate surface and positions particular substrate 594 within the path of nozzle 590. As shown in FIG. 13, a motor is used to rotate stage 592. Stage 592 preferably includes thermal control features that provide for the control of the temperature of the substrates on stage 592. Alternative designs involve the linear movement of a stage or other motions. In other embodiments, the particle stream is unfocused such that an entire substrate or the desired portions thereof is simultaneously coated without moving the substrate relative to the product flow.

If the coating is performed within the reaction chamber, the substrate is mounted to receive product compositions flowing from the reaction zone. The compositions may not be fully solidified into solid particles, although quenching may be fast enough to form solid particles. Whether or not the compositions are solidified into solid particles, the particles are preferably highly uniform. In some embodiments, the substrate is mounted near the reaction zone.

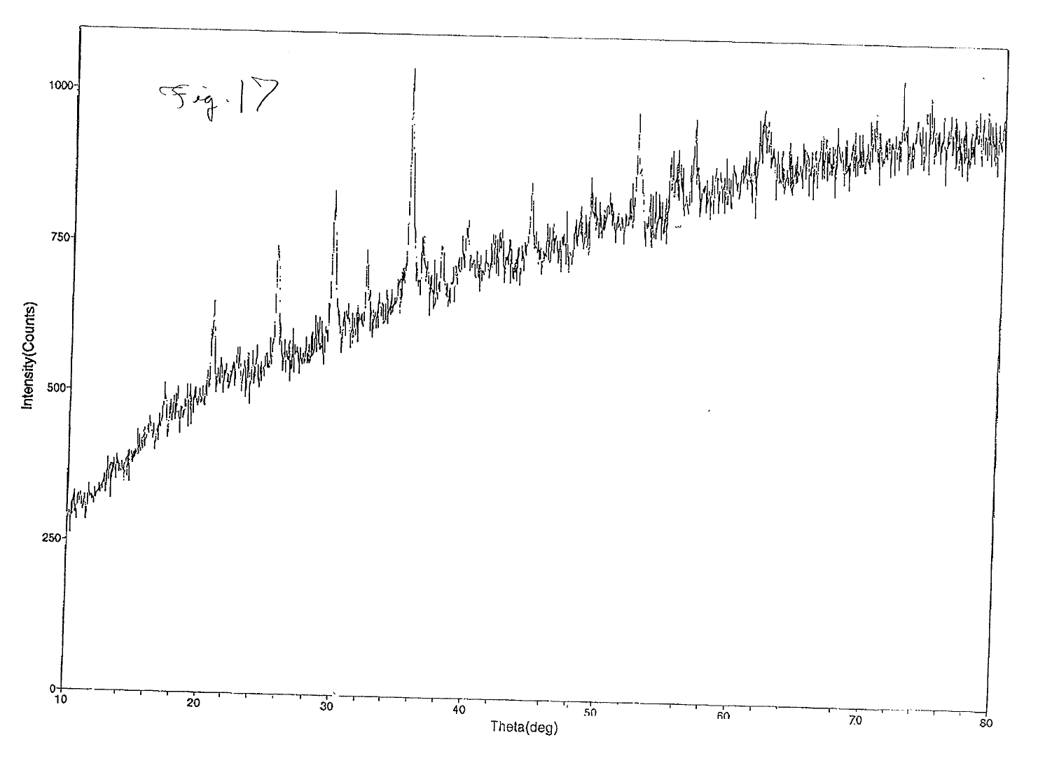

An apparatus 600 to perform substrate coating within the reaction chamber is shown schematically in FIG. 14. The reaction/coating chamber 602 is connected to a reactant supply system 604, a radiation source 606 and an exhaust 608. Exhaust 608 can be connected to a pump 610, although the pressure from the reactants themselves can maintain flow through the system.

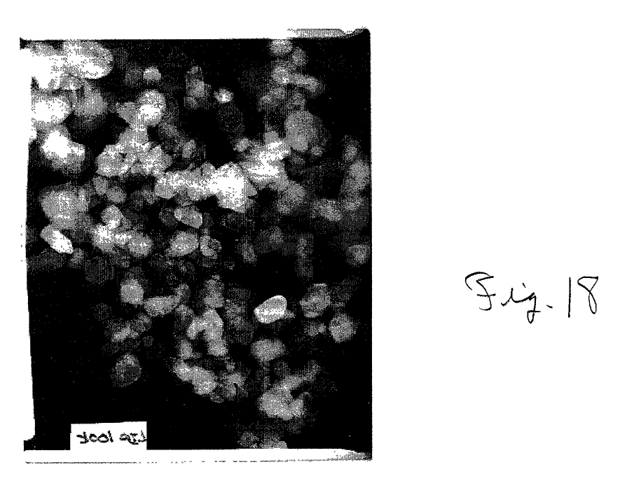

Various configurations can be used to sweep the coating across the substrate surface as the product leaves the reaction zone. One embodiment is shown in FIGS. 15 and 16. A substrate 620 moves relative to a reactant nozzle 622, as indicated by the right directed arrow. Reactant nozzle 622 is located just above substrate 620. An optical path 624 is defined by suitable optical elements that direct a light beam along path 624. Optical path 624 is located between nozzle 622 and substrate 620 to define a reaction zone just above the surface of substrate 620. The hot particles tend to stick to the cooler substrate surface. A sectional view is shown in FIG. 16. A particle coating 626 is formed as the substrate is scanned past the reaction zone.

In general, substrate 620 can be carried on a conveyor 628. In some embodiments, the position of conveyor 628 can be adjusted to alter the distance from substrate 626 to the reaction zone. Changes in the distance from substrate to the reaction zone correspondingly changes the temperature of the particles striking the substrate. The temperature of the particles striking the substrate generally alters the properties of the resulting coating and the requirements for subsequent processing, such as a subsequent heat processing consolidation of the coating. The distance between the substrate and the reaction zone can be adjusted empirically to produce desired coating properties. In addition, the stage/conveyor supporting the substrate can include thermal control features such that the temperature of the substrate can be adjusted to higher or lower temperatures, as desired.

For the production of discrete devices or structures on a substrate surface formed by the coating formed by the coating process, the deposition process can be designed to only coat a portion of the substrate. Alternatively, various patterning approaches can be used. For example, conventional approaches from integrated circuit manufacturing, such as photolithography and dry etching, can be used to pattern the coating following deposition.

Before or after patterning, the coating can be heat processed to transform the coating from a layer of discrete particles into a continuous layer. In some preferred embodiments, particles in the coating are heated to consolidate the particles into a glass or a uniform crystalline layer. The materials can be heated just above the melting point of the material to consolidate the coating into a smooth uniform material. If the temperature is not raised too high, the material does not flow significantly although the powders do convert to a homogenous material. The heating and quenching times can be adjusted to change the properties of the consolidated coatings.

Based on this description, the formation of coatings with phosphate glasses and crystalline material can be formed on substrates. The coatings can be used as protective coatings or for other functions.

The formation of coatings by light reactive deposition, silicon glass deposition and optical devices are described further in copending and commonly assigned U.S. patent application Ser. No. 09/715,935 to Bi et al., entitled “COATING FORMATION BY REACTIVE DEPOSITION,” incorporated herein by reference.

### EXAMPLES

### Example 1

### Production of Lithium Iron Phosphate by Laser Pyrolysis

This example demonstrates the synthesis of lithium iron phosphate by laser pyrolysis. These powders are useful as electroactive materials, as described in the following example. Laser pyrolysis was carried out using a reaction chamber essentially as described above with respect to FIGS. 4-6.

Ammonium phosphate-monobasic (NH₄H₂PO₄) (1.0 molar), lithium chloride (LiCl) (1.0 molar) and ferrous chloride (FeCl₂.4H₂O) (1.0 molar) precursors were dissolved in deionized water. All the precursors were obtained from Aldrich Chemical Co., Milwaukee, Wis. HCl was added to adjust the pH to a low enough value so that the iron remained in a +2 state and so that no precipitate was formed. The pH was between 0 and 2. The solution was stirred for 2-3 hours using a magnetic stirrer. The aqueous precursor solution were carried into the reaction chamber as an aerosol. C₂H₄ gas was used as a laser absorbing gas, and nitrogen was used as an inert diluent gas. Molecular oxygen (O₂) was used to maintain a neutral environment in the reaction chamber. The reactant mixture containing the precursors, N₂, O₂ and C₂H₄ was introduced into the reactant nozzle for injection into the reaction chamber. Additional parameters of the laser pyrolysis synthesis relating to the particles of Example 1 are specified in Table 1.

TABLE 1

| | 1 | 2 |
|---|---|---|
| Pressure (Torr) | 180 | 180 |
| Nitrogen F.R.- | 5 | 5 |
| Window (SLM) | | |
| Nitrogen F.R.- | 20 | 20 |
| Shielding (SLM) | | |
| Ethylene (SLM) | 5 | 3 |
| Diluent Gas | 12 | 9.5 |
| (nitrogen) | | |
| (SLM) | | |
| Oxygen (SLM) | 3 | 3.6 |
| Laser Input | 750 | 750 |
| (Watts) | | |
| Laser Output | 714 | 680 |
| (Watts) | | |
| Production Rate | ˜1 g | ˜1 g |
| (g/hr) | | |
| Precursor | 10 | 50 |
| Delivery Rate | | |
| to Atomizer* | | |
| (ml/min.) | | |

slm = standard liters per minute
Nitrogen − Win. = N₂ flow near lens 412.
Nitrogen − Sld. = N₂ flow through shielding gas opening 462.
*A majority of the aerosol precursor returns down the nozzle and is recycled.

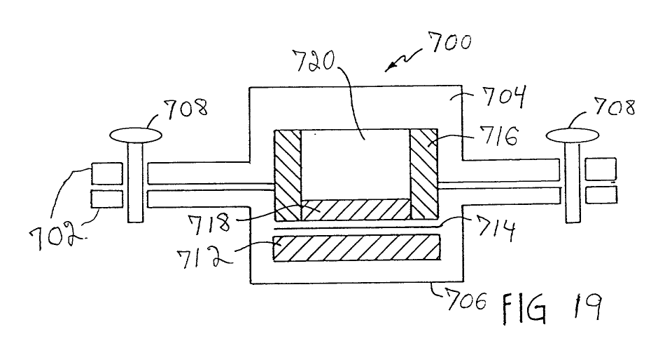

To evaluate the atomic arrangement, the samples were examined by x-ray diffraction using the Cu(Kα) radiation line on a Rigaku Miniflex x-ray diffractometer. X-ray diffractograms for a sample produced under the conditions specified in column 1 of Table 1 is shown in FIG. 17. In the diffractogram, crystalline phases were identified that corresponded to LiFePO₄. A metallic iron impurity seems to contribute a peak at about 45°. Based on the x-ray spectra, the materials produced under the conditions in the first column of Table 1 seemed more crystalline than the particles produced under the conditions in the second column of Table 1 (not shown). Additional peaks may correspond to FeFe₂O₄ from the oxidation of Fe⁰ to Fe₃O₄. There may also be some amorphous phases.

Samples of lithium iron phosphate nanoparticles produced by laser pyrolysis according to the conditions specified in Table 1 were heated in an oven under inert conditions. The oven was essentially as described above with respect to FIG. 9. Between about 100 and about 700 mg of nanoparticles were placed in an open 1 cc alumina boat within the quartz tube projecting through the oven. N₂ was flowed through a 1.0 inch diameter quartz tube at a flow rate of 100 scCm. The oven was heated to about 500° C. The particles were heated for about 3-7 hours. These particles are referred to subsequently as H1 powders. These heat treated samples yielded good battery results, as shown below.

The crystal structure of the resulting heat treated particles was determined by x-ray diffraction. The x-ray diffractogram from the heat treated sample indicates a high degree of crystallinity.

Transmission electron microscopy (TEM) was used to evaluate particle sizes and morphology of the heat treated samples. A TEM micrograph of the heat treated sample starting with materials produced under the conditions in the second column of Table 1 is shown in FIG. 18.

Also, BET surface areas were measured for the a particle sample produced by laser pyrolysis under the conditions specified in column 2 of Table 1 and for the corresponding heat treated sample. The BET surface area was determined with an N₂ gas absorbate. The BET surface area was measured with a Micromeritics Tristar 3000™ instrument. The samples produced by laser pyrolysis as specified in column 2 of Table 1 had BET surface areas of 24-25 m²/g. For the heat treated sample, particles had a BET surface area of 11-12 m²/g.

### Example 2

### Battery Testing

This examples demonstrates the capacity of cells formed with the laser pyrolysis form of lithium iron phosphate. Testing was performed to evaluate discharge capacity and charge/discharge cycling of the material.

To produce a test cell incorporating lithium iron phosphate powders produced according to the Example above, the powders were incorporated into a cathode structure. A desired quantity of lithium iron phosphate particles was weighed and combined with predetermined amounts of graphite powder (Chuetsu Graphite Works, CO., Osaka, Japan) and acetylene black powder (Catalog number C-100, Chevron Corp.) as conductive diluents, and polyvinylidene fluoride (PVDF) (type 301-F, Elf Atochem North America, Inc., Philadelphia, Pa.) dissolved in 1-methyl-2-pyrroidinone. The graphite preferably has a BET surface area of at least 50 m²/g, preferably at least about 100 m²/g, more preferably at least about 150 m²/g and even more preferably at least about 200 m²/g. The acetylene black is preferably over 55 percent compressed and more preferably is 100 percent compressed. The lithium iron phosphate cathode composition following drying included 78% by weight lithium iron phosphate nanoparticles, 5% by weight graphite, 5% by weight acetylene black, and 12% by weight PVDF.

The resulting combination of electro-active powders, electrically conductive powders, binder and liquid was mixed well in a homogenizer, T25 Basic ULTRA-TURRAX Laboratory Dispenser/Homogenizer (number 27950-01), from IKA Works, using a coarse 18 mm diameter dispersing tool (number 0593400). The homogenizer was operated for about 5 minutes.

The homogenized combination was coated onto an aluminum foil. The coated foil was then cut into discs with an area of about 2 cm². The disc was pressed in a 1.6 cm diameter die at 30,000 pounds to form a dense pellet. The pressed pellet was dried.

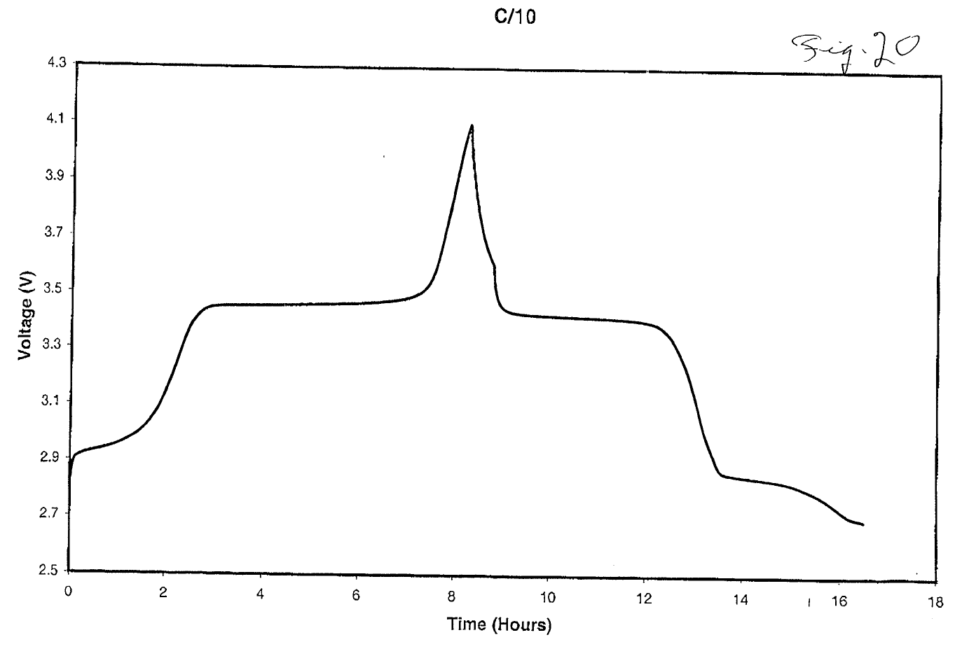

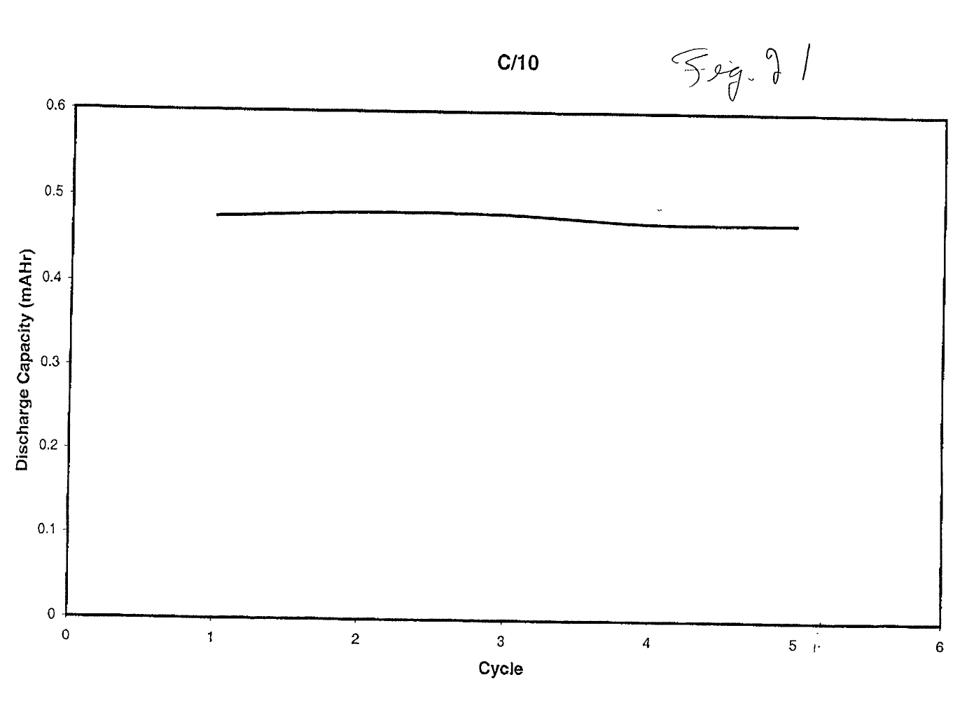

The cathodes formed from the lithium iron phosphate powders were formed into cells for testing. The samples were tested in a cell 700 with an airtight two-electrode configuration shown in FIG. 20. The casing 702 for the sample battery was obtained from Hohsen Co., Osaka, Japan. The casing included a top portion 704 and a bottom portion 706, which are secured with four screws 708. The two other screws not shown in FIG. 19 are behind the two screws shown. Lithium metal (Alfa/Aesar, Ward Hill, Mass.) was used as a negative electrode 712. Negative electrode 712 was placed within the bottom portion 706. A separator 714, Celgard® 2400 (Hoechst Celanese, Charlotte, N.C.), was placed above the lithium metal. A Teflon® ring 716 was placed above separator 714. A positive electrode 718 was placed mesh side up within Teflon® ring 716. An aluminum pellet 720 was placed above positive electrode 718, and electrolyte was added. The electrolyte from EM Industries (Hawthorne, N.Y.) was 1M LiPF₆ in 1:1 ethylene carbonate/dimethyl carbonate. A Teflon® o-ring is located between top portion 704 and bottom portion 706 to electrically insulate the two electrodes. Similarly, screws 708 are placed within a Teflon® sleeve to electrically insulate screws 708 from top portion 704 and bottom portion 706. Electrical contact between the battery tester and cell 700 is made by way of top portion 704 and bottom portion 706.

The samples were tested with a discharge/charge C/10 rate that discharges/charges the battery in about ten hours, and cycled between 4.1V to 2.7V at room temperature. The measurements were controlled by an Maccor Battery Test System, Series 4000, from Maccor, Inc. (Tulsa, Okla.). The charging/discharging profiles were recorded, and the discharge capacity of the active material during each cycle was obtained.

The cycling properties of cells produced with the lithium iron phosphate were examined. For a test cell produced with lithium iron phosphate produced under the conditions in the first column of Table 1 and heat treated as described above, the charging/discharging profiles were recorded, and the discharge capacity was obtained. In FIG. 20, a charge/discharge curve for the test cell at a C/10 current is shown. Cycling discharge capacities for the cell is shown in FIG. 21 over five cycles. The cells exhibited good cycling properties.

The embodiments described above are intended to illustrative and not limiting. Additional embodiments are within the claims. Although the present invention has been described with reference to preferred embodiments, workers skilled in the art will recognize that changes may be made in form and detail without departing from the spirit and scope of the invention.

What is claimed is:

1. A collection of particles comprising a crystalline composition with a phosphate anion, the collection of particles having an average particle size less than about 1000 nm.

2. The collection of particles of claim 1 having an average particle size from 5 nm to about 250 nm.

3. The collection of particles of claim 1 having an average particle size from 5 nm to about 100 nm.

4. The collection of particles of claim 1 having a plurality of metals in the composition.

5. The collection of particles of claim 4 wherein one of the plurality of metals is lithium.

6. The collection of particle of claim 1 having at least three metals within the composition.

7. The collection of particles of claim 1 wherein the composition comprises LiₓFePO₄, 0.1≦x≦1.

8. The collection of particles of claim 1 wherein the composition comprises LiFe₁₋ₓMnₓPO₄, 0≦x≦0.8.

9. The collection of particles of claim 1 wherein the composition comprises LiFe₁₋ₓMnₓPO₄, 0.4≦x≦0.8.

10. The collection of particles of claim 1 wherein the composition comprises MₓPO₄, wherein M is a metal, x is a rational number and x≦4.

11. The collection of particles of claim 1 wherein the composition comprises Fe₃(PO₄)₂.

12. The collection of particles of claim 1 wherein the composition comprises FePO₄.

13. The collection of particles of claim 1 having essentially no particle with an diameter greater than about 5 times the average particle size.

14. The collection of particles of claim 1 having essentially no particle with an diameter greater than about 3 times the average particle size.

15. The collection of particles of claim 1 having a distribution of particle sizes such that at least about 95 percent of the particles have a diameter greater than about 40 percent of the average diameter and less than about 160 percent of the average diameter.

16. A battery comprising an cathode, the cathode comprising the collection of particles of claim 1, the particles comprising lithium metal phosphate.

17. The battery of claim 16 wherein the lithium metal phosphate comprises LiₓFePO₄.

18. The battery of claim 16 wherein the lithium metal phosphate comprises LiFe₁₋ₓMnₓPO₄, where 0.6≦x≦0.8.

19. The battery of claim 16 comprising an anode having lithium metal.

20. The battery of claim 16 comprising an anode having a lithium intercalation compound.

21. A collection of particles comprising a collection of amorphous particles, the particles comprising a phosphate composition having an average particle size less than about 95 nm.

22. A method for producing particles comprising a composition with a polyatomic anion, the method comprising reacting a reactant stream in a gas flow, the reactant stream comprising an aerosol, the aerosol comprising a polyatomic anion precursor, the polyatomic anion precursor comprising a phosphorous precursor, a sulfur precursor or a silicon precursor.

23. The method of claim 22 wherein the reaction is driven by energy from a light beam.

24. The method of claim 23 wherein the light beam is an infrared laser beam.

25. The method of claim 22 wherein the polyatomic anion precursor comprises a phosphorous precursor.

26. The method of claim 25 wherein the phosphorous precursor comprises PO₄⁻³.

27. The method of claim 25 wherein the phosphorous precursor comprises POCl₃.

28. The method of claim 22 wherein the polyatomic anion precursor comprises a sulfur precursor.

29. The method of claim 27 wherein the sulfur precursor comprises SO₄⁻².

30. The method of claim 28 wherein the sulfur precursor is selected from the group consisting of SOCl₂ and SO₂Cl₂.

31. The method of claim 22 wherein the polyatomic anion precursor comprises a silicon precursor.

32. The method of claim 31 wherein the silicon precursor comprises SiO₄⁻⁴.

33. The method of claim 31 wherein the silicon precursor comprises SiCl₄.

34. The method of claim 31 wherein the silicon precursor comprises tetramethylammonium silicate.

35. The method of claim 22 wherein the aerosol comprises an aqueous solution.

36. The method of claim 22 wherein the reactant stream further comprises a lithium precursor.

37. The method of claim 22 wherein the reactant stream further comprises a plurality of metals.

38. The method of claim 22 wherein the reactant stream further comprises lithium precursors and iron precursors.

39. A method for producing particles comprising a composition with a polyatomic anion, the method comprising reacting a reactant stream in a gas flow, the reactant stream comprising a polyatomic anion precursor, the polyatomic anion precursor comprising a phosphorous precursor, a sulfur precursor or a silicon precursor and the reaction being driven by an intense light beam.

40. A method for producing lithium iron phosphate, the method comprising reacting a lithium precursor, an iron precursor and a phosphorous precursor in the presence of O₂ to produce crystalline lithium iron phosphate.

41. A method for producing a collection of particles comprising a mixed metal phosphate compound, the collection of particles having an average particle size of no more than 1000 nm, the method comprising heating submicron metal oxide particles combined with ammonium phosphate.

42. The method of claim 41 wherein the ammonium phosphate comprises NH₄H₂PO₄.

43. The method of claim 41 wherein the metal oxide comprises a mixture of two different metal oxides.

44. The method of claim 41 wherein the metal oxide comprises Li₂CO₃.

45. The method of claim 41 wherein the metal oxide and ammonium phosphate is also combined with Li₂CO₃.

46. A method of coating a substrate, the method comprising:
reacting a reactant stream by directing a focused radiation beam at the reactant stream to produce a product stream comprising particles downstream from the radiation beam, wherein the reaction is driven by energy from the radiation beam, the reactant stream comprising a polyatomic anion precursor, the polyatomic anion precursor comprising a phosphorous precursor, a sulfur precursor or a silicon precursor;
directing the product stream to a substrate to coat the substrate.

47. The method of claim 46 further comprising moving the substrate relative to the product stream.
